(19) United States
(12) Patent Application Publication
(10) Pub. No.: US 2022/0252995 A1
(43) Pub. Date: Aug. 11, 2022

(54) MAGNETIC TONER

(71) Applicant: CANON KABUSHIKI KAISHA, Tokyo (JP)

(72) Inventors: Daisuke Tsujimoto, Tokyo (JP); Koh Ishigami, Chiba (JP); Junichi Tamura, Ibaraki (JP); Hiroki Watanabe, Chiba (JP)

(21) Appl. No.: 17/648,588

(22) Filed: Jan. 21, 2022

(30) Foreign Application Priority Data
Jan. 29, 2021 (JP) 2021-013428
Jan. 6, 2022 (JP) 2022-001097

(51) Int. Cl. G03G 9/083

(52) U.S. Cl. CPC G03G 9/0837; G03G 9/0836; G03G 9/0838; G03G 9/0833

(57) ABSTRACT

A magnetic toner comprising a toner particle comprising a binder resin and magnetic iron oxide particles, wherein a content of the magnetic iron oxide particles in the magnetic toner is 30 to 45 mass %, the magnetic iron oxide particles contain (i) spherical magnetic iron oxide particles and (ii) at least one selected from the group consisting of hexahedral magnetic iron oxide particles and octahedral magnetic iron oxide particles, and a content of the spherical magnetic iron oxide particles in the magnetic iron oxide particles is 1.0 to 9.0% by number.

### BACKGROUND OF THE INVENTION

### Field of the Invention

The present disclosure relates to a magnetic toner used in a recording method that uses an electrophotography method, an electrostatic recording method or a magnetic toner jet recording method.

### Description of the Related Art

As use of copiers and printers has become more widespread, higher performance has been required of toners. Attention has been focused in recent years on digital printing techniques known as print on demand (POD), in which printing is directly carried out without the use of a plate-making process. In the POD market, there have been demands for toners that can achieve not only higher speeds and higher image quality than in the past, but can also provide stable images over a long period of time even when used in a variety of environments. Meanwhile, single component development methods in which a developing device having a simple structure can be advantageously used as development methods in image formation systems from the perspectives of few problems, long service life and ease of maintenance.

A number of these single component development methods are used. One such method is a jumping development method that uses a magnetic toner in which magnetic iron oxide is incorporated in a toner. A jumping development method is a method comprising causing a magnetic toner, which has been charged by triboelectric charging with a developing sleeve, to fly and adhere to an electrostatic latent image bearing member using a developing bias and visualizing an electrostatic image on the electrostatic latent image bearing member as a magnetic toner image. Jumping development methods have been widely commercialized because transportation control of a magnetic toner is easy and little contamination occurs inside a copier, a printer, or the like.

In addition, it is known that by reducing the amount of magnetic iron oxide in a magnetic toner, it is possible to provide low and uniform napping on a toner carrying member, and it is therefore possible to suppress tailing and scattering and improve image quality. As a result, it is possible to print an image without using excessive toner, which is advantageous in terms of the amount of toner consumed. From perspectives such as those mentioned above, there have been demands to reduce the amount of magnetic iron oxide in a magnetic toner.

Japanese Patent Application Publication No. 2004-325473 discloses a toner which contains a large amount of polyhedral magnetic bodies in an inner part of a toner particle and in which spherical magnetic bodies are externally added to the surface of the toner. Japanese Patent Application Publication No. 2007-322504 discloses a toner in which cubic or octahedral magnetic bodies A and spherical magnetic bodies B are contained at a weight ratio of 9:1 to 1:9 in a toner particle. Japanese Patent Application Publication No. 2017-116792 discloses a toner in which a central part of a toner particle contains a large amount of spherical magnetic bodies and the outer edge part of the toner particle contains a large amount of octahedral magnetic bodies.

### SUMMARY OF THE INVENTION

By containing a large amount of polyhedral magnetic bodies, the toner disclosed in Japanese Patent Application Publication No. 2004-325473 improves the abrasivity of a photoreceptor surface by the toner. In addition, externally adding spherical magnetic bodies achieves a spacer-like advantageous effect, reduces attraction between toners and between the toner and a developing sleeve, and prevents toner aggregation and a decrease in fluidity and developing performance.

However, the toner disclosed in Japanese Patent Application Publication No. 2004-325473 contains a large amount of magnetic bodies in the toner, meaning that napping of the toner held on a developing sleeve tends to become thicker. As a result, in cases where the toner is used for a long period of time, tailing and scattering occur if higher image quality is attempted, half tone unevenness tends to occur, and dot reproducibility is unsatisfactory. In addition, toner magnetization speed, which affects toner napping, is not discussed in this document, and because toner magnetization speed is significantly affected by magnetic bodies in the inner part of a toner particle, it cannot be expected that napping can be suitably controlled if spherical magnetic bodies are externally added.

By controlling the ratio of the amount of cubic or octahedral magnetic material particles and spherical magnetic material particles within a certain range in the toner disclosed in Japanese Patent Application Publication No. 2007-322504, it is possible to control fluidity, cohesive properties and charging performance of the toner and achieve satisfactory image density not only in low temperature low humidity environments, but also high temperature high humidity environments. However, toner magnetization speed, which affects toner napping, is not discussed with respect to the toner disclosed in Japanese Patent Application Publication No. 2007-322504, and because the proportion of spherical magnetic material particles is high, the toner magnetization speed is insufficient and it is not possible to form uniform napping on a developing sleeve. As a result, in cases where the toner is used for a long period of time, tailing and scattering occur if higher image quality is attempted, half tone unevenness tends to occur, and dot reproducibility is unsatisfactory.

By containing a large amount of octahedral magnetic bodies at the outer edge part of a toner particle, the toner disclosed in Japanese Patent Application Publication No. 2017-116792 suppresses toner charging up. However, the central part of the toner particle contains a large amount of spherical magnetic bodies, and tends to retain charge. However, toner magnetization speed, which affects toner napping, is not discussed with respect to the toner disclosed in Japanese Patent Application Publication No. 2017-116792. In addition, if an overall toner particle is observed, because the central part of the toner particle contains a large amount of spherical magnetic bodies, the toner magnetization speed is insufficient and it is not possible to form uniform napping on a developing sleeve. As a result, in cases where the toner is used for a long period of time, tailing and scattering occur if higher image quality is attempted, half tone unevenness tends to occur, and dot reproducibility is unsatisfactory.

The present disclosure provides a toner which is such that, even if used for a long period of time in a variety of environments, toner napping on a developing sleeve is suitably fine and uniform regardless of developing speed, tailing, scattering and half tone unevenness are suppressed, and a high quality image having excellent dot reproducibility can be printed.

The present disclosure relates to A magnetic toner comprising a toner particle comprising a binder resin and magnetic iron oxide particles, wherein

a content of the magnetic iron oxide particles in the magnetic toner is 30 to 45 mass %,

the magnetic iron oxide particles contain
(i) spherical magnetic iron oxide particles and
(ii) at least one selected from the group consisting of hexahedral magnetic iron oxide particles and octahedral magnetic iron oxide particles, and

a content of the spherical magnetic iron oxide particles in the magnetic iron oxide particles is 1.0 to 9.0% by number.

According to the present disclosure, it is possible to provide a toner which is such that, even if used for a long period of time in a variety of environments, toner napping on a developing sleeve is suitably fine and uniform regardless of developing speed, tailing, scattering and half tone unevenness are suppressed, and a high quality image having excellent dot reproducibility can be printed. Further features of the present invention will become apparent from the following description of exemplary embodiments.

### DESCRIPTION OF THE EMBODIMENTS

Further, in the present disclosure, the expression of “from XX to YY” or “XX to YY” indicating a numerical range means a numerical range including a lower limit and an upper limit which are end points, unless otherwise specified. Also, when a numerical range is described in a stepwise manner, the upper and lower limits of each numerical range can be arbitrarily combined.

The inventors of the present disclosure carried out diligent research with the objective of evenly forming toner napping on a developing sleeve regardless of developing speed even if a toner is used for a long period of time in a variety of environments. As a result, the inventors of the present disclosure achieved the feature of controlling the content of magnetic iron oxide particles in a magnetic toner particle (hereinafter referred to simply as a toner particle in some cases) and the ratio of the amount of spherical magnetic iron oxide particles and the amount of hexahedral magnetic iron oxide particles and octahedral magnetic iron oxide particles in a toner particle within specific ranges. The inventors of the present disclosure found that by using such a toner, toner napping on a developing sleeve is suitably fine and uniform regardless of developing speed, tailing, scattering and half tone unevenness are suppressed, and a high quality image having excellent dot reproducibility can be printed even if the toner is used for a long period of time in a variety of environments.

It is thought that the reason why such an advantageous effect can be achieved is as follows. The content of the magnetic iron oxide particles in the magnetic toner is from 30 mass % to 45 mass %. In addition, this content is preferably from 35 mass % to 42 mass %. If this content is from 30 mass % to 45 mass %, a magnetic constraining force of a magnet inside a developing sleeve to the magnetic toner is appropriately maintained, which leads to a suitable degree of toner napping on the developing sleeve. As a result, dot reproducibility is improved, and tailing, scattering and half tone unevenness can be suppressed.

In addition, the magnetic iron oxide particles in the magnetic toner (hereinafter also referred to simply as “toner”) contain (i) spherical magnetic iron oxide particles and (ii) at least one selected from the group consisting of hexahedral magnetic iron oxide particles and octahedral magnetic iron oxide particles. In addition, the content of the spherical magnetic iron oxide particles in the magnetic iron oxide particles is from 1.0% to 9.0% by number. In addition, this content is more preferably from 1.5% to 8.0% by number, and further preferably from 2.0% to 7.0% by number.

As a result of diligent research by the inventors of the present disclosure, it was found that by controlling the ratio of the amount of spherical magnetic iron oxide particles and the amount of hexahedral magnetic iron oxide particles and octahedral magnetic iron oxide particles within the range mentioned above, the toner magnetization speed could be controlled within a suitable range. It is surmised that the reason for this is as follows. Spherical magnetic iron oxide particles have no direction in which magnetization readily occurs, and therefore have a low magnetization speed, that is, a low magnetic permeability. As a result, it was found that if the proportion of spherical magnetic iron oxide particles in a magnetic toner increases, the saturation magnetization of the toner on a developing sleeve does not change, but the speed with which the toner is magnetized decreases.

Meanwhile, hexahedral magnetic iron oxide particles and octahedral magnetic iron oxide particles have protruding portions and therefore readily leak excessive toner charging, and because toner charging becomes uniform, this is useful for evenly forming napping on a developing sleeve. However, because hexahedral magnetic iron oxide particles and octahedral magnetic iron oxide particles have a higher magnetization speed than spherical magnetic iron oxide particles, if only hexahedral and octahedral magnetic iron oxide particles are used in order to obtain a desired degree of magnetization, the magnetization speed becomes excessive and napping may become thick. Such an occurrence becomes significant in cases where a toner degrades and toner fluidity decreases through long term use in a high-speed device such as a device used in the POD market in particular.

By setting the content of spherical magnetic iron oxide particles to be from 1.0% to 9.0% by number of magnetic iron oxide particles, it is possible to appropriately moderate the toner magnetization speed without altering the degree of magnetization of the toner on a developing sleeve. Therefore, it is possible to evenly form napping in a state whereby the toner is dispersed along lines of magnetic force in the developing sleeve. As a result, even if the toner is used for a long period of time, toner napping on a developing sleeve is suitably fine and uniform regardless of developing speed, dot reproducibility is improved, and tailing, scattering and half tone unevenness can be suppressed.

If the content of spherical magnetic iron oxide particles is less than 1.0% by number, the toner magnetization speed increases, magnetization occurs instantly in a magnetic field produced by the developing sleeve, and napping is formed in a cohered state with the surrounding toner. As a result, napping on the developing sleeve tends to become thick, dot reproducibility deteriorates, and tailing, scattering and half tone unevenness tend to occur. If the content of spherical magnetic iron oxide particle exceeds 9.0% by number, the toner cannot be sufficiently magnetized in a period of contact with a developing sleeve. As a result, napping on the developing sleeve becomes non-uniform, dot reproducibility deteriorates, and tailing, scattering and half tone unevenness tend to occur.

The content of the at least one selected from the group consisting of hexahedral magnetic iron oxide particles and octahedral magnetic iron oxide particles (and preferably octahedral magnetic iron oxide particles) is preferably from 91.0% to 99.0% by number, and more preferably from 92.0% to 98.5% by number.

The magnetic iron oxide particles will now be explained in detail. The magnetic iron oxide particles contain (i) spherical magnetic iron oxide particles and (ii) at least one selected from the group consisting of hexahedral magnetic iron oxide particles and octahedral magnetic iron oxide particles. Here, the shape of magnetic iron oxide particles can be confirmed by means of photographs (at a magnification ratio of 40,000 times) taken with a scanning electron microscope (SEM). The term “spherical magnetic iron oxide particles” means particles which do not have a lamellar surface and in which the entire particle surface has, for example, an elliptical or even completely spherical shape surrounded by smooth convex lines.

In addition, the term “hexahedral magnetic iron oxide particles” means particles which have protruding portions and have a cubic shape. Through scanning electron microscope (SEM) observations, hexahedral magnetic iron oxide particles are particles which have straight line portions at the outer periphery of the particle and have surfaces that appear to be approximately square. In addition, the term “octahedral magnetic iron oxide particles” means particles which have protruding portions and have a shape that is a convex polyhedron surrounded by eight triangles. Through scanning electron microscope (SEM) observations, octahedral magnetic iron oxide particles are particles which have straight line portions at the outer periphery of a particle and have a rhombic shape having surfaces that appear triangular.

In addition, of the at least one selected from the group consisting of hexahedral magnetic iron oxide particles and octahedral magnetic iron oxide particles, the magnetic iron oxide particles more preferably contain octahedral magnetic iron oxide particles. That is, the magnetic iron oxide particles more preferably contain (i) spherical magnetic iron oxide particles and (ii) octahedral magnetic iron oxide particles. The octahedral magnetic iron oxide particles have sharper protruding parts, and therefore readily leak excessive toner charging. Therefore, a better balance is achieved between toner charging and leakage, and napping instability on a developing sleeve is ameliorated. As a result, even if the toner is used for a long period of time, toner napping on a developing sleeve is suitably fine and uniform regardless of developing speed, dot reproducibility is further improved, and tailing, scattering and half tone unevenness can be better suppressed.

In addition, it is preferable for magnetic iron oxide particles to be present in the inner part of a toner particle in the magnetic toner from the perspective of readily achieving the advantageous effects mentioned above. Being present in the inner part of a toner particle means that magnetic iron oxide particles are present in a dispersed state in a binder resin.

A dispersed state can be confirmed using transmission electron microscope (TEM) observations. A state in which magnetic iron oxide particles are dispersed in a binder resin is a state in which primary magnetic iron oxide particles are present in the resin without being aggregated. It is preferable for the magnetic iron oxide particles to be uniformly dispersed with no unevenness in the distribution of the magnetic iron oxide particles in a toner particle. A state in which magnetic iron oxide particles are dispersed in a binder resin is not necessarily a state in which the magnetic iron oxide particles are uniformly dispersed, and also includes a state in which magnetic iron oxide particles are slightly unevenly distributed in the binder resin. In such a dispersed state, a toner particle can be produced by melt kneading for example.

The degree of magnetization and ease of magnetization of the toner are affected not only by the vicinity of the toner surface, but also the entire volume of the toner, including the inner part of a toner particle. Therefore, magnetic bodies in the inner part of a toner particle have a significant effect. Therefore, in order to readily achieve the advantageous effects mentioned above, it is preferable to control the content of the magnetic iron oxide particles in the inner part of the toner particle within the range mentioned above.

Of the magnetic iron oxide particles, the (i) spherical magnetic iron oxide particles and the (ii) at least one selected from the group consisting of hexahedral magnetic iron oxide particles and octahedral magnetic iron oxide particles may be produced separately and then blended. It is more preferable for the magnetic iron oxide particles to be produced in such a way that both types of magnetic iron oxide particle are contained as a result of a same reaction.

By using magnetic iron oxide containing both types of magnetic iron oxide particles produced using the same reaction, dispersion of both types of particles in the magnetic iron oxide is improved. As a result, the toner magnetization speed in the inner part of toner particles becomes uniform. As a result, even if the toner is used for a long period of time, toner napping on a developing sleeve is suitably fine and uniform regardless of developing speed, dot reproducibility is further improved, and tailing, scattering and half tone unevenness can be better suppressed.

The number average diameter of the magnetic iron oxide particles is preferably 0.10 μm to 0.30 μm, and more preferably 0.10 μm to 0.18 μm. If the number average particle diameter of the magnetic iron oxide particles falls within the range mentioned above, dispersibility of the magnetic iron oxide particles in the toner is improved and the toner magnetization speed becomes uniform from toner particle to toner particle. As a result, even if the toner is used for a long period of time, toner napping on a developing sleeve is suitably fine and uniform regardless of developing speed, dot reproducibility is further improved, and tailing, scattering and half tone unevenness can be better suppressed.

In addition, the number average particle diameter of the spherical magnetic iron oxide particles is preferably greater than the number average particle diameter of the at least one selected from the group consisting of hexahedral magnetic iron oxide particles and octahedral magnetic iron oxide particles. By satisfying this relationship, the speed of magnetization is suitably moderated in the initial stage of toner magnetization, and it is possible to better prevent the toner from becoming instantly magnetized in a magnetic field produced by a developing sleeve and possible to form napping in a state in which the toner is better dispersed. As a result, even if the toner is used for a long period of time, toner napping on a developing sleeve is suitably fine and uniform regardless of developing speed, dot reproducibility is further improved, and tailing, scattering and half tone unevenness can be better suppressed.

The value of (number average particle diameter of spherical magnetic iron oxide particles)−(number average diameter of the at least one selected from the group consisting of hexahedral magnetic iron oxide particles and octahedral magnetic iron oxide particles) is preferably 0.03 μm to 0.10 μm, and more preferably 0.05 μm to 0.08 μm.

The number average diameter of the spherical magnetic iron oxide particles is preferably 0.15 μm to 0.30 μm, and more preferably 0.18 μm to 0.22 μm. The number average diameter of the at least one selected from the group consisting of hexahedral magnetic iron oxide particles and octahedral magnetic iron oxide particles is preferably 0.08 μm to 0.30 μm, and more preferably 0.10 μm to 0.16 μm.

The intensity of magnetization of the magnetic iron oxide particles in a magnetic field of 796 kA/m is preferably from 85 Am²/kg to 90 Am²/kg, and more preferably from 85 Am²/kg to 87 Am²/kg. If the intensity of magnetization in a magnetic field of 796 kA/m is 85 Am²/kg or more, napping stability on a developing sleeve is improved. As a result, dot reproducibility is further improved, and tailing and scattering can be better suppressed.

In addition, if the intensity of magnetization in a magnetic field of 796 kA/m is 90 Am²/kg or less, the thickness of napping on a developing sleeve is fine and uniform. As a result, even if the toner is used for a long period of time, toner napping on a developing sleeve is suitably fine and uniform regardless of developing speed, dot reproducibility is further improved, and tailing, scattering and half tone unevenness can be better suppressed. The intensity of magnetization in a magnetic field of 796 kA/m can be controlled by adjusting the diameter of the magnetic iron oxide particles, the content of Fe²⁺ in the magnetic iron oxide particles, or the amount of metallic elements such as silicon and zinc contained in the inner part of magnetic iron oxide particles.

The maximum specific magnetic permeability of the magnetic iron oxide particles in a magnetic field of 0 kA/m to 796 kA/m is preferably from 2.70 to 2.80, and more preferably from 2.71 to 2.75.

By setting the maximum specific magnetic permeability to fall within the range mentioned above, the toner magnetization speed on a developing sleeve becomes more suitable. As a result, it is possible to form uniform napping in a state whereby the toner is more dispersed along lines of magnetic force in the developing sleeve. As a result, even if the toner is used for a long period of time, toner napping on a developing sleeve is suitably fine and uniform regardless of developing speed, dot reproducibility is further improved, and tailing, scattering and half tone unevenness can be better suppressed. The maximum specific magnetic permeability can be controlled by adjusting the ratio of the (i) spherical magnetic iron oxide particles and the (ii) at least one selected from the group consisting of hexahedral magnetic iron oxide particles and octahedral magnetic iron oxide particles in the magnetic iron oxide particles, the diameters of the magnetic iron oxide particles, or the amount of metallic element present in the magnetic iron oxide particles.

Magnetic iron oxide particles such as those listed below can be used as the magnetic iron oxide particles. Specific examples thereof include magnetic iron oxide particles such as magnetite, maghemite and ferrite; and magnetic iron oxide particles containing other metal oxides. Triiron tetraoxide (Fe₃O₄), iron sesquioxide (γ-Fe₂O₃), iron zinc oxide (ZnFe₂O₄), iron yttrium oxide (Y₃Fe₅O₁₂), iron cadmium oxide (Cd₃Fe₂O₄), iron gadolinium oxide (Gd₃Fe₅O₁₂), iron copper oxide (CuFe₂O₄), iron lead oxide (PbFei₂O₁₉), iron nickel oxide (NiFe₂O₄), iron neodymium oxide (NdFe₂O₃), iron barium oxide (BaFe₁₂O₁₉), iron magnesium oxide (MgFe₂O₄), iron manganese oxide (MnFe₂O₄), iron lanthanum oxide (LaFeO₃), iron powder (Fe), and the like, were known in the past. Particularly preferred magnetic iron oxide particles are triiron tetraoxide and γ-iron sesquioxide. It is possible to use a single type of magnetic iron oxide particles mentioned above, or a combination of two or more types thereof.

In order to control the degree of magnetization of the toner on a developing sleeve within a suitable range, it is preferable to incorporate a specific type of metallic element in core particles of the magnetic iron oxide particles and form a coat layer containing a specific type of metallic element on the surface of the core particles.

From the perspective of achieving a balance between degree of magnetization, triboelectric charging properties and heat resistance in particular, it is more preferable for the magnetic iron oxide particles to have: core particles containing a compound containing at least one selected from the group consisting of silicon and zinc; and a coat layer containing a compound containing at least one selected from the group consisting of silicon, aluminum and zinc on the surface of the core particles. More preferably, the magnetic iron oxide particles each have: a core particle that contains a silicon-containing compound; and, on the surface of the core particle, a coat layer that contains a silicon-containing compound and an aluminum-containing compound.

In addition, the content of silicon element in core particles of the magnetic iron oxide particles is preferably from 0.10 atom % to 1.50 atom %, and more preferably from 0.20 atom % to 0.80 atom %, if the amount of iron element in the magnetic iron oxide particles is taken to be 100 atom %. By controlling the amount of silicon in core particles within the range mentioned above, uniformity of composition within particles between individual magnetic iron oxide particles is improved, and uniformity of degree of magnetization and magnetization speed are also improved. As a result, uniformity of degree of magnetization and magnetization speed between particles increase, napping of the toner on a developing sleeve becomes finer and more uniform, and stability also increases. As a result, dot reproducibility is further improved, and tailing, scattering and half tone unevenness can be better suppressed.

In addition, the content of silicon element in the coat layer is preferably from 0.01 atom % to 0.50 atom %, and more preferably from 0.05 atom % to 0.30 atom %, if the amount of iron element in the magnetic iron oxide particles is taken to be 100 atom %. Furthermore, the content of aluminum element in the coat layer is preferably from 0.05 atom % to 1.50 atom %, and more preferably from 0.10 atom % to 1.00 atom %, if the amount of iron element in the magnetic iron oxide particles is taken to be 100 atom %. By forming such a coat layer, toner charging uniformity is improved, and napping stability on a developing sleeve is improved. As a result, dot reproducibility is further improved, and tailing, scattering and half tone unevenness can be better suppressed.

A suitable production method for obtaining the magnetic iron oxide particles is explained below, but methods for producing the magnetic iron oxide particles are not limited to this. The magnetic iron oxide particles can be obtained by carrying out a first reaction step for forming magnetic iron oxide seed particles; a second reaction step for adjusting the pH following the first reaction step so as to grow the seed particles until almost the reaction end point; and a third reaction step for adjusting the pH again following the second reaction step so as to obtain the target magnetic iron oxide particles.

By dividing the reaction process into three stages in this way, it is possible to obtain magnetic iron oxide particles containing spherical magnetic iron oxide particles and at least one selected from the group consisting of hexahedral magnetic iron oxide particles and octahedral magnetic iron oxide particles. In addition, it is possible to carry out a step for coating a coat layer on the surface of the magnetic iron oxide either at the same time as the third reaction step or between the second reaction step and the third reaction step. The particle diameter and shape of the magnetic iron oxide can be adjusted by altering the pH in the steps, the oxygen-containing gas flow rate, the reaction temperature, the oxidation reaction rate, raw material ratios, and the like. In particular, the particle diameter of the magnetic iron oxide can be increased by lowering the oxygen-containing gas flow rate in the steps.

In a case where spherical magnetic iron oxide particles and hexahedral/octahedral magnetic iron oxide particles are to be produced in the same reaction, it is preferable to adjust the pH to 8.0 to 9.0 in the first reaction step. The content of spherical magnetic iron oxide particles in the magnetic iron oxide particles can be increased by lowering the pH in the first reaction step or increasing the oxidation reaction rate. In addition, the content of spherical magnetic iron oxide particles can be increased by lowering the pH in the third reaction step. In addition, octahedral magnetic iron oxide particles can be readily obtained by setting the pH to be 9.5 or more in the second reaction step.

Detailed explanations will now be given of the reaction steps for obtaining the magnetic iron oxide particles, but the method for producing the magnetic iron oxide particles is not limited to these.

First Reaction Step

An aqueous solution of a ferrous salt is reacted with an aqueous solution of an alkali hydroxide at an amount of 0.90 to 1.00 equivalents relative to the ferrous salt in the aqueous solution of a ferrous salt. A water-soluble silicate is added to the obtained ferrous salt solution containing colloidal ferrous hydroxide at an amount such that the amount of Si is 0.10 to 1.50 atom % relative to Fe. Moreover, the amount of Si being 0.10 to 1.50 atom % relative to Fe means that the amount of Si atoms is 0.10 to 1.50 if the amount of Fe atoms contained in the solution is taken to be 100. Next, the pH of the ferrous salt reaction liquid containing colloidal ferrous hydroxide is adjusted to 8.0 to 9.0. Next, while heating to a temperature within the range 70 to 100° C., an oxygen-containing gas is passed through the reaction liquid, and an oxidation reaction is carried out until the iron oxidation reaction rate reaches 7 to 14%, thereby generating magnetite seed crystal particles.

Second Reaction Step

An aqueous solution of an alkali hydroxide such as sodium hydroxide is added at an amount of 1.01 to 1.50 equivalents relative to the ferrous salt reaction liquid containing the obtained magnetite seed crystal particles and colloidal ferrous hydroxide, and the pH is adjusted again to 8.5 or more, and more preferably 9.5 or more. Next, an oxidation reaction is carried out by passing an oxygen-containing gas through the reaction liquid while heating to a temperature within the range 70 to 100° C.

Third Reaction Step

Following completion of the second reaction step, the temperature of a suspension containing magnetic iron oxide particles is adjusted to 80° C. or higher, and preferably 90° C. or higher, and the pH is adjusted to 6.0 or lower so as to terminate the reaction.

In addition, in cases where the surface of the magnetic iron oxide particles is to contain a compound containing Si and/or Al, the following procedure is carried out. Following completion of the second reaction step, a water-soluble silicate, a water-soluble aluminum salt or a water-soluble silicate and a water-soluble aluminum salt are added to the suspension containing magnetic iron oxide particles. Next, the temperature of the suspension is adjusted to 80° C. or higher, and preferably 85° C. or higher, and the pH is adjusted within the range 5 to 9 so as to precipitate and deposit a compound containing Si and/or Al at the surface of the magnetic iron oxide particles, and the pH is adjusted to 6.0 or less so as to terminate the reaction. When a water-soluble silicate is introduced in such a case, an aqueous solution containing another element may be introduced at the same time.

In addition, by subjecting the magnetic iron oxide to a mechanochemical treatment or a heat treatment following completion of the third reaction step, it is possible to fix a compound containing Si and/or Al at the surface of the magnetic iron oxide. It is possible to incorporate a desired element as required by adding a salt of one or two or more elements selected from among Mn, Zn, Ni, Cu, Al, Ti and Si in addition to iron in the reaction steps. It is possible to use a sulfate, a nitrate, a chloride, or the like, as the salt. The total added amount of the salt is preferably 0 to 10 atom %, more preferably 0 to 8 atom %, and further preferably 0 to 5 atom %, relative to Fe.

A resin commonly used in magnetic toners can be used as the binder resin. Specifically, it is possible to use the following polymers. Homopolymers of styrene or substituted styrene compounds, such as polystyrene, poly-p-chlorostyrene and poly(vinyl toluene); styrene-based copolymers such as styrene-p-chlorostyrene copolymers, styrene-vinyl toluene copolymers, styrene-vinyl naphthalene copolymers, styrene-acrylic acid ester copolymers, styrene-methacrylic acid ester copolymers, styrene-α-chloromethyl methacrylate copolymers, styrene-vinyl methyl ether copolymers, styrene-vinyl ethyl ether copolymers, styrene-vinyl methyl ketone copolymers and styrene-acrylonitrile-indene copolymers; poly(vinyl chloride), phenolic resins, natural resin-modified phenolic resins, natural resin-modified maleic acid resins, acrylic resins, methacrylic resins, poly(vinyl acetate) resins, silicone resins, polyester resins, polyurethane resins, polyamide resins, furan resins, epoxy resins, xylene resins, poly(vinyl butyral) resins, terpene resins, cumarone-indene resins and petroleum-based resins.

Of these, it is preferable for the binder resin to be a resin having a polyester structure from the perspective of dispersion of magnetic iron oxide in the binder resin. If dispersibility of the magnetic iron oxide is improved, the toner magnetization speed becomes uniform from particle to particle. As a result, even if the toner is used for a long period of time, toner napping on a developing sleeve is suitably fine and uniform regardless of developing speed, dot reproducibility is further improved, and tailing, scattering and half tone unevenness can be better suppressed.

“Polyester structure” means a part derived from a polyester, and a resin having a polyester structure encompasses, for example, a polyester resin and a hybrid resin in which a polyester structure is bound to another polymer. Examples of other resins include vinyl-based resins, polyurethane resins, epoxy resins and phenol resins. Among resins having a polyester structure, it is preferable for the binder resin to comprise a hybrid resin in which a polyester resin is bound to a vinyl-based resin.

By using such a hybrid resin, dispersibility of the magnetic iron oxide particles in the binder resin is further improved. Therefore, the toner magnetization speed between toner particles becomes uniform. As a result, even if the toner is used for a long period of time, toner napping on a developing sleeve is suitably fine and uniform regardless of developing speed, dot reproducibility is further improved, and tailing, scattering and half tone unevenness can be better suppressed.

Components that constitute the polyester resin will now be explained in detail. Moreover, it is possible to use one type or two or more types of the components listed below according to the type and intended use of the component in question. Examples of the divalent acid component that constitutes the polyester resin include the following dicarboxylic acids and derivatives thereof. Benzenedicarboxylic acids and acid anhydrides and lower alkyl esters thereof, such as phthalic acid, terephthalic acid, isophthalic acid and phthalic acid anhydride; alkyldicarboxylic acids, such as succinic acid, adipic acid, sebacic acid and azelaic acid, and acid anhydrides and lower alkyl esters thereof; C1-50 alkenylsuccinic acid and alkylsuccinic acid compounds, and acid anhydrides and lower alkyl esters thereof; and unsaturated dicarboxylic acids, such as fumaric acid, maleic acid, citraconic acid and itaconic acid, and acid anhydrides and lower alkyl esters thereof.

Meanwhile, examples of the dihydric alcohol component that constitutes the polyester resin include the following compounds. Ethylene glycol, polyethylene glycol, 1,2-propane diol, 1,3-propane diol, 1,3-butane diol, 1,4-butane diol, 2,3-butane diol, diethylene glycol, triethylene glycol, 1,5-pentane diol, 1,6-hexane diol, neopentyl glycol, 2-methyl-1,3-propane diol, 2-ethyl-1,3-hexane diol, 1,4-cyclohexanedimethanol (CHDM), hydrogenated bisphenol A, bisphenol compounds represented by formula (I) below and derivatives thereof, and diol compounds represented by formula (II) below.

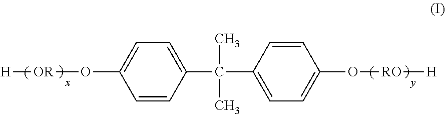

In formula (I), R is an ethylene group or propylene group, x and y are each an integer of 0 or more, and the average value of x+y is 0 to 10.

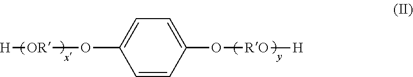

In the formula (II), R′ is —CH₂CH₂—, —CH₂—CH(CH₃)— or —CH₂—C(CH₃)(CH₃)—, x′ and y′ are each independently an integer of 0 or higher, and the average value of x′+y′ is 0 to 10.

In addition to the divalent carboxylic acid compound and dihydric alcohol compound mentioned above, trivalent or higher carboxylic acid compounds and trihydric or higher alcohol components may be contained as constituent components of the polyester resin. Trivalent or higher carboxylic acid compounds are not particularly limited, but examples thereof include trimellitic acid, trimellitic anhydride and pyromellitic acid. In addition, examples of trihydric or higher alcohol compounds include trimethylolpropane, pentaerythritol and glycerin.

The method for producing the polyester resin is not particularly limited, and a publicly known method can be used. For example, the polyester resin can be produced by supplying the divalent carboxylic acid compound and dihydric alcohol compound mentioned above, and then polymerizing by means of an esterification reaction or transesterification reaction and a condensation reaction. In addition, the polymerization temperature when producing the polyester resin is not particularly limited, but preferably falls within the range 180° C. to 290° C. When polymerizing the polyester, it is possible to use a polymerization catalyst such as a titanium-based catalyst, a tin-based catalyst, zinc acetate, antimony trioxide or germanium dioxide.

A hybrid resin in which a polyester resin is bound to a vinyl-based resin is more preferably a hybrid resin in which a polyester resin is bound to a vinyl-based copolymer from the perspective of dispersion of the magnetic iron oxide in the binder resin. If dispersibility of the magnetic iron oxide is improved, the toner magnetization speed becomes uniform from particle to particle. As a result, even if the toner is used for a long period of time, toner napping on a developing sleeve is suitably fine and uniform regardless of developing speed, dot reproducibility is further improved, and tailing, scattering and half tone unevenness can be better suppressed. In cases where a hybrid resin is used, at least styrene can be advantageously used as a vinyl-based monomer used for producing the vinyl-based copolymer in the hybrid resin. The vinyl-based copolymer is preferably a polymer of a styrene-based monomer and a (meth)acrylic acid-based monomer. The content of styrene is preferably 70 mass % or more in the vinyl-based monomer.

Examples of vinyl-based monomers other than styrene used for producing the vinyl-based copolymer include styrene-based monomers and (meth)acrylic acid-based monomers such as those listed below. Examples of styrene-based monomers include styrene derivatives such as o-methylstyrene, m-methylstyrene, p-methylstyrene, p-phenylstyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, p-chlorostyrene, 3,4-dichlorostyrene, m-nitrostyrene, o-nitrostyrene and p-nitrostyrene.

Examples of (meth)acrylic acid-based monomers include acrylic acid and acrylic acid esters, such as acrylic acid, methyl acrylate, ethyl acrylate, propyl acrylate, n-butyl acrylate, isobutyl acrylate, n-octyl acrylate, dodecyl acrylate, 2-ethylhexyl acrylate, stearyl acrylate, 2-chloroethyl acrylate and phenyl acrylate; methacrylic acid and methacrylic acid esters, such as methacrylic acid, methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate and diethylaminoethyl methacrylate; and acrylic acid and methacrylic acid derivatives such as acrylonitrile, methacrylonitrile and acrylamide.

Furthermore, examples of monomers that constitute the vinyl-based copolymer include acrylic acid and methacrylic acid esters, such as 2-hydroxyethyl acrylate, 2-hydroxyethyl methacrylate and 2-hydroxypropyl (meth)acrylate; and hydroxyl group-containing monomers such as 4-(1-hydroxy-1-methylbutyl)styrene and 4-(1-hydroxy-1-methylhexyl)styrene.

It is possible to additionally use a variety of monomers capable of vinyl polymerization in the vinyl-based copolymer according to need. Examples of such monomers include ethylene-based unsaturated monoolefins, such as ethylene, propylene, butylene and isobutylene; unsaturated polyenes, such as butadiene and isoprene; halogenated vinyl compounds, such as vinyl chloride, vinylidene chloride, vinyl bromide and vinyl fluoride; vinyl esters, such as vinyl acetate, vinyl propionate and vinyl benzoate; vinyl ethers, such as vinyl methyl ether, vinyl ethyl ether and vinyl isobutyl ether; vinyl ketones, such as vinyl methyl ketone, vinyl hexyl ketone and methyl isopropenyl ketone; N-vinyl compounds, such as N-vinylpyrrole, N-vinylcarbazole, N-vinylindole and N-vinylpyrrolidone; vinylnaphthalene compounds; unsaturated dibasic acids, such as maleic acid, citraconic acid, itaconic acid, alkenylsuccinic acid compounds, fumaric acid and mesaconic acid; unsaturated dibasic acid anhydrides, such as maleic acid anhydride, citraconic acid anhydride, itaconic acid anhydride and alkenylsuccinic acid anhydride compounds; half esters of unsaturated basic acids, such as methyl maleate half ester, ethyl maleate half ester, butyl maleate half ester, methyl citraconate half ester, ethyl citraconate half ester, butyl citraconate half ester, methyl itaconate half ester, methyl alkenylsuccinate half esters, methyl fumarate half ester and ethyl mesaconate half ester; unsaturated basic acid esters, such as dimethyl maleate and dimethyl fumarate; anhydrides of α,β-unsaturated acid such as acrylic acid, methacrylic acid, crotonic acid and cinnamic acid; anhydrides of these α,β-unsaturated acids and lower fatty acids; and carboxylic acid group-containing monomers, such as alkenylmalonic acid compounds, alkenylglutaric acid compounds, alkenyladipic acid compounds, and anhydrides and monoesters of these.

The vinyl-based copolymers mentioned above may, if necessary, be polymers that are crosslinked using a crosslinkable monomer such as those exemplified below. Examples of crosslinkable monomers include aromatic divinyl compounds, diacrylate compounds linked by alkyl chains, diacrylate compounds linked by ether bond-containing alkyl chains, diacrylate compounds linked by chains including aromatic groups and ether bonds, polyester type diacrylate compounds, and polyfunctional crosslinking agents. Examples of the aromatic divinyl compounds mentioned above include divinylbenzene and divinylnaphthalene.

Examples of the diacrylate compounds linked by alkyl chains mentioned above include ethylene glycol diacrylate, 1,3-butylene glycol diacrylate, 1,4-butane diol diacrylate, 1,5-pentane diol diacrylate, 1,6-hexane diol diacrylate, neopentyl glycol diacrylate and compounds in which the acrylate moiety in the compounds mentioned above is replaced with a methacrylate moiety.

Examples of the diacrylate compounds linked by ether bond-containing alkyl chains mentioned above include diethylene glycol diacrylate, triethylene glycol diacrylate, tetraethylene glycol diacrylate, polyethylene glycol #400 diacrylate, polyethylene glycol #600 diacrylate, dipropylene glycol diacrylate, and compounds in which the acrylate moiety in the compounds mentioned above is replaced with a methacrylate moiety.

Examples of the diacrylate compounds linked by chains including aromatic groups and ether bonds mentioned above include polyoxyethylene (2)-2,2-bis(4-hydroxyphenyl)propane diacrylate, polyoxyethylene (4)-2,2-bis(4-hydroxyphenyl)propane diacrylate and compounds in which the acrylate moiety in the compounds mentioned above is replaced with a methacrylate moiety. An example of a polyester type diacrylate compound is the product MANDA (available from Nippon Kayaku Co., Ltd.).

Examples of the polyfunctional crosslinking agents mentioned above include pentaerythritol triacrylate, trimethylolethane triacrylate, trimethylolpropane triacrylate, tetramethylolmethane tetraacrylate, oligoester acrylates, compounds in which the acrylate moiety in the compounds mentioned above is replaced with a methacrylate moiety; triallyl cyanurate and triallyl trimellitate.

The hybrid resin is a bound product of a polyester resin and a vinyl-based resin. Therefore, in order to bind the polyester resin to the vinyl-based resin, it is preferable to carry out polymerization using a compound able to react with monomers of both resins (hereinafter referred to as a “bireactive compound”). Examples of such a bireactive compound include fumaric acid, acrylic acid, methacrylic acid, citraconic acid, maleic acid and dimethyl fumarate. Of these, fumaric acid, acrylic acid and methacrylic acid can be advantageously used. The method for obtaining the hybrid resin can be a method in which the raw material monomers of the polyester structure and the raw material monomers of the vinyl-based copolymer are reacted either simultaneously or sequentially.

The vinyl-based copolymer may be produced using a polymerization initiator. The polymerization initiator is preferably used at an amount of from 0.05 parts by mass to 10 parts by mass relative to 100 parts by mass of the monomers from the perspective of efficiency.

Examples of such polymerization initiators include 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), dimethyl-2,2′-azobisisobutyrate, 1,1′-azobis(1-cyclohexanecarbonitrile), 2-carbamoylazoisobutyronitrile, 2,2′-azobis(2,4,4-trimethylpentane), 2-phenylazo-2,4-dimethyl-4-methoxyvaleronitrile, 2,2′-azobis(2-methylpropane), ketone peroxides such as methyl ethyl ketone peroxide, acetylacetone peroxide and cyclohexanone peroxide, 2,2-bis(t-butylperoxy)butane, t-butyl hydroperoxide, cumene hydroperoxide, 1,1,3,3-tetramethylbutyl hydroperoxide, di-t-butyl peroxide, t-butylcumyl peroxide, dicumyl peroxide, α,α′-bis(t-butylperoxyisopropyl)benzene, isobutyl peroxide, octanoyl peroxide, decanoyl peroxide, lauroyl peroxide, 3,5,5-trimethylhexanoyl peroxide, benzoyl peroxide, m-toluoyl peroxide, diisopropyl peroxydicarbonate, di-2-ethylhexyl peroxydicarbonate, di-n-propyl peroxydicarbonate, di-2-ethoxyethyl peroxycarbonate, dimethoxyisopropyl peroxydicarbonate, di(3-methyl-3-methoxybutyl) peroxycarbonate, acetylcyclohexylsulfonyl peroxide, t-butyl peroxyacetate, t-butyl peroxyisobutyrate, t-butyl peroxyneodecanoate, t-butylperoxy-2-ethylhexanoate, t-butyl peroxylaurate, t-butyl peroxybenzoate, t-butyl peroxyisopropyl carbonate, di-t-butyl peroxyisophthalate, t-butyl peroxyallyl carbonate, t-amyl peroxy-2-ethylhexanoate, di-t-butyl peroxyhexahydroterephthalate and di-t-butyl peroxyazelate.

The mixing ratio of the polyester resin and the vinyl-based copolymer is more preferably a mass ratio of 50:50 to 90:10 from the perspective of controlling a crosslinked structure at a molecular level and the perspective of dispersion of the magnetic iron oxide particles in the binder resin. If dispersibility of the magnetic iron oxide particles is improved, the toner magnetization speed becomes uniform between particles. As a result, even if the toner is used for a long period of time, toner napping on a developing sleeve is suitably fine and uniform regardless of developing speed, dot reproducibility is further improved, and tailing, scattering and half tone unevenness can be better suppressed.

In addition, the softening point of the binder resin is preferably from 95° C. to 170° C. This softening point is preferably from 110° C. to 160° C., and more preferably from 120° C. to 150° C. A binder resin having such a softening point is preferably contained at an amount of 50.0 mass % or more in the binder resin.

Other Components

The magnetic toner particle may contain a mold-release agent (a wax) in order to impart the magnetic toner with mold-release properties. The wax is preferably a Fischer Tropsch wax from the perspectives of ease of dispersion in the magnetic toner particle and high mold-release properties. In addition, a hydrocarbon wax may be used. For example, it is possible to use a wax such as a low molecular weight polyethylene, a low molecular weight polypropylene, a microcrystalline wax or a paraffin wax. It is possible to use one type of wax or a combination of two or more types of wax according to need.

The time at which to add the wax may be while carrying out melt kneading during production of the magnetic toner, but may also be during production of the binder resin, and is selected as appropriate from among existing methods. The wax content is preferably from 1.0 parts by mass to 20.0 parts by mass relative to 100.0 parts by mass of the binder resin. If the wax content falls within the range mentioned above, a satisfactory mold-release effect is achieved, dispersion in the magnetic toner is good, adhesion of the magnetic toner to an electrostatic image bearing member tends to occur, and contamination of a surface of a cleaning member tends not to occur.

The magnetic toner particle may contain a charge control agent in order to stabilize charging characteristics. The content of the charge control agent varies according to the type thereof and physical properties of other constituent materials of the toner particle, but is generally preferable for this content to be from 0.10 parts by mass to 10.0 parts by mass, and more preferably from 0.10 parts by mass to 5.0 parts by mass, relative to 100.0 parts by mass of the binder resin. It is possible to use one type or two or more types of the charge control agent, depending on the type and intended use of the toner.

Examples of charge control agents that negatively charge a toner include the following. Organic metal complexes (monoazo metal complexes; acetylacetone metal complexes); metal complexes and metal salts of aromatic hydroxycarboxylic acids and aromatic dicarboxylic acids; aromatic mono- and poly-carboxylic acids, and metal salts and anhydrides thereof; esters; and phenol derivatives such as bisphenol. Of these, monoazo metal complexes and metal salts able to achieve stable charging characteristics are particularly preferred. In addition, a charge control resin can also be used, and can be used in combination with the charge control agents mentioned above.

Examples of charge control resins include sulfur-containing polymers and sulfur-containing copolymers. Sulfur-containing polymers and sulfur-containing copolymers can be produced using a variety of polymerization methods, but preferred polymerization methods include bulk polymerization methods and solution polymerization methods in which a polymerization solvent is not used or used in a small amount.

A solvent such as methanol, ethanol, propanol, 2-propanol, propanone, 2-butanone or dioxane can be used as the reaction solvent. In cases where a mixture of these solvents is used, the mass ratio of methanol, 2-butanone and 2-propanol is preferably 2:1:1 to 1:5:5.

Examples of polymerization initiators include t-butylperoxy-2-ethylhexanoate, cumyl perpivalate, t-butyl peroxylaurate, benzoyl peroxide, lauroyl peroxide, octanoyl peroxide, di-t-butyl peroxide, t-butylcumyl peroxide, dicumyl peroxide, 2,2′-azobisisobutyronitrile, 2,2′-azobis(2-methylbutyronitrile), 2,2′-azobis(2,4-dimethylvaleronitrile), 2,2′-azobis(4-methoxy-2,4-dimethylvaleronitrile), 4,4′-azobis-4-cyanovaleric acid, 1,1′-azobis(cyclohexane-1-carbonitrile), 1,1′-di(t-butyl peroxy)3-methylcyclohexane, 1,1-bis(t-butyl peroxy)3,3,5-trimethylcyclohexane, 1,1′-di(t-butyl peroxy)3,3,5-trimethylcyclohexane, 1,1-bis(t-butyl peroxy)cyclohexane, 1,4-bis(t-butyl peroxycarbonyl)cyclohexane, 2,2-bis(t-butyl peroxy)octane, n-butyl-4,4-bis(t-butyl peroxy)valerate, 2,2-bis(t-butyl peroxy)butane, 1,3-bis(t-butyl peroxy-isopropyl)benzene, 2,5-dimethyl-2,5-di(t-butyl peroxy)hexane, 2,5-dimethyl-2,5-di(t-butyl peroxy)hexane, 2,5-dimethyl-2,5-di(benzoyl peroxy)hexane, di-t-butyl diperoxy isobutyrate, 2,2-bis(4,4-di-t-butyl peroxy cyclohexyl)propane, di-t-butyl peroxy α-methylsuccinate, di-t-butyl peroxy dimethyl glutarate, di-t-butyl peroxy hexahydroterephthalate, di-t-butyl peroxy azelate, 2,5-dimethyl-2,5-di(t-butyl peroxy)hexane, diethylene glycol-bis(t-butyl peroxy carbonate), di-t-butyl peroxy trimethyladipate, tris(t-butyl peroxy)triazine and vinyltris(t-butyl peroxy)silane.

It is possible to use one of these in isolation, or a combination thereof. It is preferable to use 2,2′-azobis(2-methylbutyronitrile), 4,4′-azobis-4-cyanovaleric acid, 1,1′-di(t-butyl peroxy)3-methylcyclohexane or 1,1-bis(t-butyl peroxy)3,3,5-trimethylcyclohexane in isolation, or a combination of these. These polymerization initiators are preferred from the perspectives of being able to adjust the molecular weight of a sulfur-containing polymer or sulfur-containing copolymer within a range that is suitable for the magnetic toner, reduce the amount of unreacted monomer and increasing the polymerization addition rate.

Examples of charge control agents that positively charge a toner include the following. Products modified by means of nigrosine and fatty acid metal salts; quaternary ammonium salts such as tributylbenzyl ammonium-1-hydroxy-4-naphthosulfonic acid salts, tetrabutyl ammonium tetrafluoroborate, and analogs thereof; onium salts such as phosphonium salts, and lake pigments thereof; triphenylmethane dyes and Lake pigments thereof (examples of laking agents include phosphotungstic acid, phosphomolybdic acid, phosphotungstic-molybdic acid, tannic acid, lauric acid, gallic acid, ferricyanic acid and ferrocyanic compounds); and metal salts of higher fatty acids. It is possible to use one of these charge control agents or a combination of two or more types thereof. Of these, charge control agents such as nigrosine-based compounds and quaternary ammonium salts are preferred.

Inorganic fine particles having a low number average primary particle diameter, which have high potential for imparting the toner surface with fluidity, may be used in the magnetic toner. Examples thereof include inorganic fine particles able to increase fluidity by being externally added to the toner. For example, fluororesin fine particles such as vinylidene fluoride fine particles and polytetrafluoroethylene fine particles; silica fine particles such as silica fine particles produced using a wet method and silica fine particles produced using a dry method; treated silica fine particles obtained by surface treating these silica fine particles with a treatment agent such as a silane coupling agent, a titanium coupling agent or a silicone oil; titanium oxide fine particles; alumina fine particles; treated titanium oxide fine particles and treated alumina fine particles.

In cases where improved fluidity is an objective, the specific surface area, as measured using the nitrogen adsorption BET method, is preferably at least 30 m²/g, and more preferably from 50 m²/g to 300 m²/g. The content of inorganic fine particles is preferably from 0.01 parts by mass to 8.0 parts by mass, and more preferably from 0.1 parts by mass to 4.0 parts by mass, relative to 100 parts by mass of the toner particle.

Other external additives may, if necessary, be added to the magnetic toner. For example, auxiliary electrification agents, electrical conductivity-imparting agents, anti-caking agents, mold-release agents at the time of hot roller fixing, and resin fine particles and inorganic fine particles that act as abrasive materials. Examples of abrasive materials include cerium oxide fine particles, silicon carbide fine particles and strontium titanate fine particles. These external additives should be thoroughly mixed using a mixer such as a Henschel mixer.

Toner Production Method

The method for producing the toner particle is not particularly limited, and a publicly known method such as a pulverization method, a suspension polymerization method or an emulsion aggregation method can be used. An example of a pulverization method will now be explained, but the method for producing the toner particle is not limited to this. In a raw material mixing step, prescribed amounts of a binder resin, magnetic iron oxide particles and, if necessary, other components such as a colorant, a wax and a charge control agent are weighed out as materials that constitute the magnetic toner particle, blended, and thoroughly mixed using a mixer.

Next, the mixed materials are melt kneaded so as to disperse the other components in the binder resin. In the raw material mixing step, the melt kneading should be carried out using a hot kneader. A toner particle is obtained by cooling and solidifying the obtained melt kneaded product, and then pulverizing and classifying. A toner is then obtained by thoroughly mixing the inorganic fine particles with the toner particle using a mixer if necessary.

Examples of the mixer include those listed below. A Henschel mixer (available from Mitsui Mining Co., Ltd.); a super mixer (available from Kawata Co., Ltd.); a Ribocone (available from Okawara Mfg. Co., Ltd.); a Nauta Mixer, Turbulizer or Cyclomix (available from Hosokawa Micron Corp.); a spiral pin mixer (available from Pacific Machinery & Engineering Co., Ltd.); and a Loedige Mixer (available from Matsubo Corporation).

Examples of the hot kneader include those listed below. A KRC kneader (available from Kurimoto, Ltd.); a Buss co-kneader (available from Buss AG); a TEM type extruder (available from Shibaura Machine Co., Ltd.); a TEX twin screw kneader (available from Japan Steel Works, Ltd.); a PCM kneader (available from Ikegai Corporation); a three-roll mill, mixing roll mill or kneader (available from Inoue Mfg. Inc.); a Kneadex (available from Mitsui Mining Co., Ltd.); an MS type pressurizing kneader or Kneaderuder (available from Moriyama Seisakusho); and a Banbury mixer (available from Kobe Steel Ltd.).

Examples of the pulverizer include those listed below. A counter jet mill, micron jet or Innomizer (available from Hosokawa Micron Corp.); an IDS type mill or PJM jet pulverizer (available from Nippon Pneumatic Mfg. Co., Ltd.); a cross jet mill (available from Kurimoto, Ltd.); an Ulmax (available from Nisso Engineering Co., Ltd.); an SK Jet-O-Mill (available from Seishin Enterprise Co., Ltd.); a Kryptron (available from Kawasaki Heavy Industries, Ltd.); a Turbo Mill (available from Turbo Kogyo); and a Super Rotor (available from Nisshin Engineering).

Examples of the classifier include those listed below. A Classiel, Micron Classifier or Spedic Classifier (available from Seishin Enterprise Co., Ltd.); a Turbo Classifier (available from Nisshin Engineering); a Micron separator, Turboplex (ATP), TSP Separator or TTSP Separator (available from Hosokawa Micron Corp.); an Elbow Jet (available from Nittetsu Mining Co., Ltd.); a dispersion separator (available from Nippon Pneumatic Mfg. Co., Ltd.); and a YM Micro Cut (available from Yasukawa Corporation).

Examples of classifying apparatuses able to be used for classifying and separating coarse particles include those listed below. An Ultrasonic (available from Koei Sangyo Co., Ltd.); a Rezona Sieve or Gyro Sifter (available from Tokuju Co., Ltd.); a Vibrasonic System (available from Dalton); a Soniclean (available from Sinto Kogyo); a Turbo Screener (available from Turbo Kogyo); a Micron Sifter (available from Makino Mfg. Co., Ltd.); and a circular vibrating sieve.

Methods for measuring physical property values will now be described. Measurement of Shape and Number Average Particle Diameter of Magnetic Iron Oxide Particles

The particle shape and number average particle diameter of the magnetic iron oxide is observed/measured using a “S-4800 scanning electron microscope” (produced by Hitachi High-Technologies Corporation). Observations are carried out using the following procedure. First, 0.025 g of a sample (magnetic iron oxide particles) are weighed out, and 10 g of pure water is added. This solution is dispersed for 5 minutes using an ultrasonic disperser. Next, this dispersion is spread on an aluminum foil, and moisture is thoroughly dried off. The dried sample is placed on a SEM stand and observed. The lengths of the long axis and short axis of magnetic iron oxide particles are measured using an electron microscope photograph (at a magnification of 40,000 times), and the average value of these lengths is taken to be the number average particle diameter of the magnetic iron oxide.

Several photographs are taken with different fields of view, and the arithmetic mean is calculated for average particle diameters of a total of 500 or more spherical magnetic iron oxide particles and hexahedral and/or octahedral magnetic iron oxide particles. Moreover, selection of particles of each shape is such that in each photograph, all particles are counted except particles having sizes of 0.03 μm or more and particles whose shape or diameter cannot be distinguished due to particle overlap or the like. The arithmetic mean of the average particle diameter of spherical magnetic iron oxide particles included in the 500 or more particles is taken to be the number average particle diameter of the spherical magnetic iron oxide particles.

In addition, the arithmetic mean of the average particle diameter of hexahedral magnetic iron oxide particles or octahedral magnetic iron oxide particles included in the 500 or more particles is taken to be the number average particle diameter of the hexahedral magnetic iron oxide particles or octahedral magnetic iron oxide particles. However, in a case where the total number of any type of particle is less than 5, observations are carried out until a minimum of 5 or more particles can be observed.

Moreover, the magnetic iron oxide contained in the magnetic toner can be obtained by dissolving the magnetic toner through heating in a tetrahydrofuran solution or toluene solution and then extracting only the magnetic iron oxide from the solution using a magnet. If isolated magnetic iron oxide particles are observed as-is using an electron microscope, a great deal of overlap occurs and there are few particles for which it is possible to accurately confirm the particle diameter or shape. Therefore, isolated magnetic iron oxide particles are weighed out into a beaker, diluted 400 times with pure water, and treated for 2 minutes using a 50 kHz ultrasonic cleaning device so as to disperse the magnetic iron oxide particles. Next, an aluminum foil is laid on a hot plate heated to a temperature of 100° C., and the pure water containing the dispersed magnetic iron oxide particles is added dropwise as thinly as possible using a dropping pipette. The pure water is volatilized, and the dried magnetic iron oxide particles, together with the aluminum foil, are attached to an electron microscope sample table using electrically conductive carbon tape, and observed.

Content of Magnetic Iron Oxide Particles in Magnetic Toner

The content of the magnetic iron oxide particles in the magnetic toner is calculated using the following procedure. A sample is prepared by placing 1.0 g of magnetic toner and 120 mL of toluene in a beaker and then dispersing for 10 minutes by means of ultrasonic dispersion. Next, a magnetic stirrer is placed in the beaker, and the beaker is covered with an aluminum foil so that the toluene does not evaporate. This sample bottle is then placed on a hot plate set to a temperature of 80° C., and the magnetic toner is stirred and dissolved for 10 hours. After stirring for 10 hours, the sample solution is subjected to magnetic separation and magnetic iron oxide particles in the magnetic toner are obtained. The content of magnetic iron oxide particles in the magnetic toner is calculated from the mass of the obtained magnetic iron oxide particles.

Content (% by Number) of Spherical, Hexahedral and Octahedral Magnetic Iron Oxide Particles in Magnetic Iron Oxide Particles

The content of spherical, hexahedral and octahedral magnetic iron oxide particles can be calculated using the following method. Magnetic iron oxide particles, which have been separated from the magnetic toner using the means described above, are observed with a S-4800 scanning electron microscope using a method similar to that described above. A total of 500 or more magnetic iron oxide particles are observed, and from the shape of these particles, the proportions by number of spherical, hexahedral and octahedral magnetic iron oxide particles are calculated. Moreover, in each photograph, all particles are counted except particles having sizes of 0.03 μm or more and particles whose shape or diameter cannot be distinguished due to particle overlap or the like.

Oxidation Reaction Rate

The oxidation reaction rate of the ferrous salt in the first reaction step is determined by measuring the Fe²⁺ content in the reaction solution and calculating the oxidation reaction rate using the following formula.

(A−B)÷A×100=oxidation reaction rate (%)

In the formula above, A denotes the Fe²⁺ content in the reaction solution immediately after the aqueous solution of the ferrous salt is mixed with the aqueous alkali solution, and B denotes the Fe²⁺ content in the ferrous salt reaction solution that contains a mixture of ferrous hydroxide and magnetite particles.

Method for Quantitatively Determining Amount of Si in Core Particles of Magnetic Iron Oxide Particles (Internal Si Content)

The amount of Si in core particles of the magnetic iron oxide particles is measured in the following way. 3 g of magnetic iron oxide particles is suspended in 300 mL of a 3 mol/L aqueous solution of sodium hydroxide. After stirring for 30 minutes at 50° C., the suspension is filtered using a 0.1 μm membrane filter and dried. Using this sample, elements from Na to U in the magnetic iron oxide particles are directly measured in a He atmosphere using an Axios advanced wavelength-dispersive X-Ray fluorescence analysis apparatus (produced by Spectris PLC). Using a liquid sample cup supplied with the analysis apparatus, a PP (polypropylene) film is laid on the bottom surface of the cup, a sufficient amount of the sample is placed in the cup, a layer having a uniform thickness is formed on the bottom surface, and a lid is placed on the cup. Measurements are carried out at an output of 2.4 kW. Analysis is carried out using a FP (fundamental parameter) method. The amount of Si in the magnetic iron oxide is taken to be the internal Si content, and is calculated as a value determined in terms of element relative to the amount of Fe contained in the magnetic iron oxide (that is, the amount of iron element is taken to be 100 atom %).

Content of Si and Al Contained in Coat Layer on Surface of Core Particle of Magnetic Iron Oxide Particles (Surface Si Content and Surface Al Content)

First, the total amount of Si and Al element in the magnetic iron oxide is determined. The amount of Si and the amount of Al in the magnetic iron oxide are measured using an Axios advanced wavelength-dispersive X-Ray fluorescence analysis apparatus (produced by Spectris PLC), and is calculated as a value determined in terms of element relative to the amount of Fe contained in the magnetic iron oxide. The apparatus is operated in the same way as described above. Next, 3 g of magnetic iron oxide particles is suspended in 300 mL of a 3 mol/L aqueous solution of sodium hydroxide. After stirring for 30 minutes at 50° C., the suspension is filtered using a 0.1 μm membrane filter and dried. The amount of Si and the amount of Al in the obtained magnetic iron oxide are measured, and the difference from the total amount of Si and Al prior to treatment with sodium hydroxide is taken to be the amount of Si and the amount of Al contained in the coat layer of the magnetic iron oxide particles. The amount of Si and the amount of Al contained in the magnetic iron oxide particles are calculated as values determined in terms of element relative to the amount of Fe contained in the magnetic iron oxide (that is, the amount of iron element is taken to be 100 atom %).

Method for Measuring Magnetic Properties

Magnetic properties are measured using a VSM-P7 vibrating sample magnetometer produced by Toei Industry Co., Ltd. at a sample temperature of 25° C. in an external magnetic field of 796 kA/m. Measurement conditions are as follows. Sample pan: cylindrical pan having a diameter of 6 mm and a thickness of 2 mm TC (sec): 0.03
S. step (%): 10
S. speed (min): 0.1
Maximum magnetization (kA/m): 796

Softening Point of Binder Resin

The softening point of the resin is measured using a constant load extrusion type capillary rheometer “Flow Tester CFT-500D Flow Characteristics Analyzer” (available from Shimadzu Corporation), with the measurements being carried out in accordance with the manual provided with the apparatus. In this apparatus, the temperature of a measurement sample filled in a cylinder is increased while a constant load is applied from above by means of a piston, thereby melting the sample, the molten measurement sample is extruded through a die at the bottom of the piston, and a flow curve is obtained from the amount of piston travel and the temperature during this process. In addition, the softening temperature was taken to be the “melting temperature by the half method” described in the manual provided with the “Flow Tester CFT-500D Flow Characteristics Analyzer”. Moreover, the melting temperature in the half method is calculated as follows.

First, half of the difference between the amount of piston travel at the completion of outflow (Smax) and the amount of piston travel at the start of outflow (Smin) is determined (this is designated as X; X=(Smax−Smin)/2). Next, the temperature in the flow curve when the amount of piston travel reaches the sum of X and Smin is taken to be the melting temperature by the half method. The measurement sample is prepared by subjecting approximately 1.3 g of a resin to compression molding for approximately 60 seconds at approximately 10 MPa in a 25° C. environment using a tablet compression molder (a Standard Manual Newton Press NT-100H produced by NPa System Co., Ltd.) to provide a cylindrical shape with a diameter of approximately 8 mm.

The measurement conditions for the Flow Tester CFT-500D are as follows.
Test mode: Rising temperature method
Start temperature: 50° C.
End point temperature: 200° C.
Measurement interval: 1.0° C.
Temperature increase rate: 4.0° C./min
Piston cross section area: 1.000 cm²
Test load (piston load): 10.0 kgf (0.9807 MPa)
Preheating time: 300 seconds
Diameter of die orifice: 1.0 mm
Die length: 1.0 mm

Measurement of Weight Average Particle Diameter (D4) of Toner (Particles)

The weight-average particle diameter (D4) of the toner (particle) is calculated by carrying out measurements using a precision particle size distribution measuring device which employees a pore electrical resistance method and uses a 100 μm aperture tube (a “Coulter Counter Multisizer 3” (registered trademark) produced by Beckman Coulter) and accompanying dedicated software that is used to set measurement conditions and analyze measured data (“Beckman Coulter Multisizer 3 Version 3.51” produced by Beckman Coulter) (number of effective measurement channels: 25,000), and then analyzing the measurement data. A solution obtained by dissolving special grade sodium chloride in deionized water at a concentration of approximately 1 mass %, such as “ISOTON II” (produced by Beckman Coulter), can be used as an aqueous electrolyte solution used in the measurements. Moreover, dedicated software was set up as follows before carrying out measurements and analysis.

On the “Standard Operating Method (SOM) alteration screen” in the dedicated software, the total count number in control mode is set to 50,000 particles, the number of measurements is set to 1, and the Kd value is set to “standard particle 10.0 μm” (Beckman Coulter). By pressing the threshold value/noise level measurement button, threshold values and noise levels are automatically set. In addition, the current is set to 1600 μA, the gain is set to 2, the aqueous electrolyte solution is set to ISOTON II, and the “Flush aperture tube after measurement” option is checked. On the “Screen for converting from pulse to particle diameter” in the dedicated software, the bin interval is set to logarithmic particle diameter, the particle diameter bin is set to 256 particle diameter bin, and the particle diameter range is set to from 2 μm to 60 μm. The specific measurement method is as described in steps (1) to (7) below.

(1) 200 mL of the aqueous electrolyte solution is placed in a dedicated Multisizer 3 250 mL glass round bottomed beaker, the beaker is set on a sample stand, and a stirring rod is rotated anticlockwise at a rate of 24 rotations/second. By carrying out the “Aperture tube flush” function of the dedicated software, dirt and bubbles in the aperture tube are removed.

(2) 30 mL of the aqueous electrolyte solution is placed in a 100 mL glass flat bottomed beaker, and approximately 0.3 mL of a diluted liquid, which is obtained by diluting “Contaminon N” (a 10 mass % aqueous solution of a neutral detergent for cleaning precision measurement equipment, which has a pH of 7 and comprises a non-ionic surfactant, an anionic surfactant and an organic builder, produced by Wako Pure Chemical Industries, Ltd.) 3-fold with deionized water, is added to the beaker as a dispersant.

(3) A prescribed amount of ion exchanged water is placed in a water bath of an “Ultrasonic Dispersion System Tetora 150” (available from Nikkaki Bios Co., Ltd.) having an electrical output of 120 W, in which 2 oscillators having an oscillation frequency of 50 kHz are housed so that their phases are staggered by 180°, and approximately 2 mL of the Contaminon N is added to the water bath.

(4) The beaker mentioned in section (2) above is placed in a beaker-fixing hole of the ultrasonic wave disperser, and the ultrasonic wave disperser is activated. The height of the beaker is adjusted so that the resonant state of the liquid surface of the aqueous electrolyte solution in the beaker is at a maximum.

(5) While the aqueous electrolyte solution in the beaker mentioned in section (4) above is being irradiated with ultrasonic waves, approximately 10 mg of toner (particles) are added a little at a time to the aqueous electrolyte solution and dispersed therein. The ultrasonic wave dispersion treatment is continued for a further 60 seconds. Moreover, when carrying out the ultrasonic wave dispersion, the temperature of the water bath is adjusted as appropriate to a temperature of from 10° C. to 40° C.

(6) The aqueous electrolyte solution mentioned in section (5) above, in which the toner (particles) are dispersed, is added dropwise by means of a pipette to the round bottomed beaker mentioned in section (1) above, which is disposed on the sample stand, and the measurement concentration is adjusted to approximately 5%. Measurements are carried out until the number of particles measured reaches 50,000.

(7) The weight-average particle diameter (D4) is calculated by analyzing measurement data using the accompanying dedicated software. Moreover, when setting the graph/vol. % with the dedicated software, the “average diameter” on the analysis/volume-based statistical values (arithmetic mean) screen is weight-average particle diameter (D4).

The present disclosure will now be explained in detail on the basis of working examples. However, the present disclosure is not limited to these working examples. Numbers of “parts” in formulations below are on a mass basis unless explicitly stated otherwise.

Magnetic iron oxide particles used in the magnetic toner are produced in the manner described below.

Production Example of Magnetic Iron Oxide Particles 1

First Reaction Step

A ferrous salt suspension was prepared by mixing 16 L of an aqueous ferrous sulfate solution containing 1.5 mol/L of Fe²⁺ (24 mol of Fe²⁺) and 15.2 L of a 3.0 mol/L solution of sodium hydroxide (corresponding to 0.95 equivalents relative to the Fe²⁺; that is, 2OH/Fe=0.95) and adjusting to a pH of 8.4. At this point, a product obtained by diluting 26.6 g of No. 3 water glass (28.8 mass % of SiO₂) (corresponding to 0.50 atom % in terms of Si relative to Fe; that is, Si/Fe (atom ratio)=0.50) with 0.5 L of ion exchanged water was added as a silicon component to sodium hydroxide. Air was passed at a rate of 70 L/min through the ferrous salt suspension at a temperature of 90° C., and an oxidation reaction was carried out until the ferrous salt oxidation reaction rate was 11%, thereby obtaining a ferrous salt suspension containing magnetite seed crystal particles.

Second Reaction Step

A suitable amount of a 3.0 mol/L solution of sodium hydroxide was added to the ferrous salt suspension containing the magnetite seed crystal particles so as to adjust the pH to 10.5, and air was passed at a rate of 70 L/min through the suspension at a temperature of 90° C., thereby obtaining magnetic iron oxide core particle precursor 1.

Third Reaction Step+Coating Treatment

To the suspension containing magnetic iron oxide core particle precursor 1 were added suitable amounts of No. 3 water glass as a silicon component and a 1.9 mol/L solution of aluminum sulfate as an aluminum component so as to attain Si/Fe and Al/Fe values shown in Table 1. Dilute sulfuric acid was added so as to adjust the pH to 5.8 and the temperature of the suspension was adjusted to 90° C., thereby forming a coat layer and obtaining magnetic iron oxide 1.

The obtained magnetic iron oxide 1 was filter pressed and washed with water. Following the washing with water, the electrical conductivity was 40 mS. The obtained magnetic iron oxide was then filtered, dried and pulverized using ordinary methods. The obtained magnetic iron oxide 1 contained 5.0% by number of magnetic iron oxide particles having a spherical shape and 95.0% by number of octahedral magnetic iron oxide particles, and had a number average particle diameter of 0.14 μm. The composition and preparation conditions of magnetic iron oxide 1 are shown in Table 1, and physical properties of magnetic iron oxide particles 1 are shown in Table 2.

Production Examples of Magnetic Iron Oxide Particles 2 to 16

Magnetic iron oxide particles 2 to 16 were obtained by adjusting production conditions in the production example of magnetic iron oxide particles 1 in the manner shown in Table 1. Physical property values of obtained magnetic iron oxide particles 2 to 16 are shown in Table 2.

TABLE 1-1

| Magnetic | First stage reaction | | | | | | | | |
|---|---|---|---|---|---|---|---|---|---|
| iron oxide | Ferrous | | Equivalence | | | | Air flow | Oxidation | Reaction |
| particle | salt | Alkali | ratio | Water-soluble silicate | | | rate | reaction | temperature |
| No. | solution | hydroxide | 2OH/Fe | | Si/Fe | pH | (L/min) | rate (%) | (° C.) |
| 1 | Ferrous | Sodium | 0.95 | No. 3 water | 0.50 | 8.4 | 70 | 11 | 90 |
| | sulfate | hydroxide | | glass | | | | | |
| 2 | Ferrous | Sodium | 0.95 | No. 3 water | 0.50 | 8.5 | 70 | 10 | 90 |
| | sulfate | hydroxide | | glass | | | | | |
| 3 | Ferrous | Sodium | 0.95 | No. 3 water | 0.50 | 8.3 | 70 | 12 | 90 |
| | sulfate | hydroxide | | glass | | | | | |
| 4 | Ferrous | Sodium | 0.94 | No. 3 water | 0.50 | 8.3 | 70 | 12 | 90 |
| | sulfate | hydroxide | | glass | | | | | |
| 5 | Ferrous | Sodium | 0.96 | No. 3 water | 0.50 | 8.6 | 71 | 9 | 90 |
| | sulfate | hydroxide | | glass | | | | | |
| 6 | Ferrous | Sodium | 0.97 | No. 3 water | 0.50 | 8.6 | 72 | 9 | 90 |
| | sulfate | hydroxide | | glass | | | | | |
| 7 | Ferrous | Sodium | 0.93 | No. 3 water | 0.50 | 8.2 | 69 | 12 | 90 |
| | sulfate | hydroxide | | glass | | | | | |
| 8 | Ferrous | Sodium | 0.93 | No. 3 water | 0.50 | 8.2 | 68 | 13 | 90 |
| | sulfate | hydroxide | | glass | | | | | |
| 9 | Ferrous | Sodium | 0.92 | No. 3 water | 1.0 | 8.1 | 63 | 13 | 85 |
| | sulfate | hydroxide | | glass | | | | | |
| 10 | Ferrous | Sodium | 0.92 | No. 3 water | 1.0 | 8.1 | 63 | 13 | 85 |
| | sulfate | hydroxide | | glass | | | | | |
| 11 | Ferrous | Sodium | 0.92 | No. 3 water | 1.0 | 8.1 | 66 | 14 | 85 |
| | sulfate | hydroxide | | glass | | | | | |
| 12 | Ferrous | Sodium | 0.92 | No. 3 water | 1.1 | 8.1 | 66 | 14 | 80 |
| | sulfate | hydroxide | | glass | | | | | |
| 13 | Ferrous | Sodium | 0.92 | No. 3 water | 1.1 | 8.0 | 60 | 14 | 75 |
| | sulfate | hydroxide | | glass | | | | | |
| 14 | Ferrous | Sodium | 0.98 | No. 3 water | 1.1 | 8.9 | 75 | 8 | 90 |
| | sulfate | hydroxide | | glass | | | | | |
| 15 | Ferrous | Sodium | 1.04 | No. 3 water | 1.1 | 6.8 | 60 | 100 | 90 |
| | sulfate | hydroxide | | glass | | | | | |
| 16 | Ferrous | Sodium | 1.05 | No. 3 water | 1.1 | 8.5 | 60 | 100 | 90 |
| | sulfate | hydroxide | | glass | | | | | |

TABLE 1-2

| Magnetic | Second stage reaction | | | | Third stage reaction + coating treatment | | | | |
|---|---|---|---|---|---|---|---|---|---|
| iron oxide | | | Air flow | Reaction | | | Reaction | | |
| particle | Alkali | | rate | temperature | Acidic | | temperature | | |
| No. | hydroxide | pH | (L/min) | (° C.) | component | pH | (° C.) | Si/Fe | Al/Fe |
| 1 | Sodium | 10.5 | 70 | 90 | Dilute | 5.8 | 90 | 0.10 | 0.40 |
| | hydroxide | | | | sulfuric acid | | | | |
| 2 | Sodium | 10.5 | 70 | 90 | Dilute | 5.8 | 90 | 0.10 | 0.40 |
| | hydroxide | | | | sulfuric acid | | | | |
| 3 | Sodium | 10.5 | 70 | 90 | Dilute | 5.8 | 90 | 0.10 | 0.40 |
| | hydroxide | | | | sulfuric acid | | | | |
| 4 | Sodium | 10.5 | 70 | 90 | Dilute | 5.7 | 90 | 0.10 | 0.40 |
| | hydroxide | | | | sulfuric acid | | | | |
| 5 | Sodium | 10.5 | 71 | 90 | Dilute | 5.9 | 90 | 0.10 | 0.40 |
| | hydroxide | | | | sulfuric acid | | | | |
| 6 | Sodium | 10.5 | 72 | 90 | Dilute | 5.9 | 90 | 0.10 | 0.40 |
| | hydroxide | | | | sulfuric acid | | | | |
| 7 | Sodium | 10.5 | 69 | 90 | Dilute | 5.6 | 90 | 0.10 | 0.40 |
| | hydroxide | | | | sulfuric acid | | | | |
| 8 | Sodium | 10.5 | 68 | 90 | Dilute | 5.5 | 90 | 0.10 | 0.40 |
| | hydroxide | | | | sulfuric acid | | | | |
| 9 | Sodium | 10.5 | 65 | 85 | Dilute | 5.5 | 85 | 0.50 | 1.10 |
| | hydroxide | | | | sulfuric acid | | | | |
| 10 | Sodium | 8.9 | 65 | 85 | Dilute | 5.5 | 85 | 0.50 | 1.10 |
| | hydroxide | | | | sulfuric acid | | | | |
| 11 | Sodium | 8.5 | 65 | 85 | Dilute | 5.4 | 85 | 0.50 | 1.10 |
| | hydroxide | | | | sulfuric acid | | | | |
| 12 | Sodium | 8.5 | 63 | 80 | Dilute | 5.4 | 80 | 0.60 | 1.20 |
| | hydroxide | | | | sulfuric acid | | | | |
| 13 | Sodium | 8.5 | 60 | 75 | Dilute | 5.4 | 75 | 0.60 | 1.20 |
| | hydroxide | | | | sulfuric acid | | | | |
| 14 | Sodium | 8.5 | 75 | 90 | Dilute | 6.0 | 90 | 0.60 | 1.20 |
| | hydroxide | | | | sulfuric acid | | | | |
| 15 | — | — | 60 | — | Dilute | 6.8 | 90 | 0.60 | 1.20 |
| | | | | | sulfuric acid | | | | |
| 16 | — | — | 60 | — | Dilute | 7.0 | 90 | 0.60 | 1.20 |
| | | | | | sulfuric acid | | | | |

In the table, Si/Fe and Al/Fe values denote the proportions of Si and Al relative to 100 atoms of iron element contained in the magnetic iron oxide particles.

TABLE 2

| | | | | Number | Number | | Maximum | | | |
|---|---|---|---|---|---|---|---|---|---|---|
| | | | Number | average | average | | specific | | | |
| | | | average | particle | particle | Intensity of | magnetic | | | |
| | | | particle | diameter | diameter | magnetization | permeability | | | |
| Magnetic | | Content (% | diameter | (μm) of | (μm) of | (Am²/kg) | (−) | | | |
| iron | | by number) | (μm) of | spherical | hexahedral | in magnetic | in magnetic | Internal | Surface | Surface |
| oxide | | of spherical | magnetic | magnetic | or octahedral | field of | field of | Si | Si | Al |
| particle | Particle | magnetic | iron oxide | iron oxide | magnetic iron | 796 | 0 to 796 | content | content | content |
| No. | shape | bodies | particles | particles | oxide particles | kA/m | kA/m | Si/Fe | Si/Fe | Al/Fe |
| 1 | Spherical | 5.0 | 0.14 | 0.20 | 0.14 | 86 | 2.72 | 0.50 | 0.10 | 0.40 |
| | + | | | | | | | | | |
| | octahedral | | | | | | | | | |
| 2 | Spherical | 2.0 | 0.12 | 0.19 | 0.12 | 85 | 2.75 | 0.50 | 0.10 | 0.40 |
| | + | | | | | | | | | |
| | octahedral | | | | | | | | | |
| 3 | Spherical | 7.0 | 0.15 | 0.21 | 0.15 | 87 | 2.71 | 0.50 | 0.10 | 0.40 |
| | + | | | | | | | | | |
| | octahedral | | | | | | | | | |
| 4 | Spherical | 8.0 | 0.16 | 0.21 | 0.16 | 87 | 2.70 | 0.50 | 0.10 | 0.40 |
| | + | | | | | | | | | |
| | octahedral | | | | | | | | | |
| 5 | Spherical | 1.5 | 0.11 | 0.18 | 0.11 | 85 | 2.80 | 0.50 | 0.10 | 0.40 |
| | + | | | | | | | | | |
| | octahedral | | | | | | | | | |
| 6 | Spherical | 1.5 | 0.10 | 0.18 | 0.10 | 85 | 2.81 | 0.50 | 0.10 | 0.40 |
| | + | | | | | | | | | |
| | octahedral | | | | | | | | | |
| 7 | Spherical | 8.0 | 0.17 | 0.22 | 0.17 | 87 | 2.69 | 0.50 | 0.10 | 0.40 |
| | + | | | | | | | | | |
| | octahedral | | | | | | | | | |
| 8 | Spherical | 8.1 | 0.18 | 0.22 | 0.18 | 87 | 2.69 | 0.50 | 0.10 | 0.40 |
| | + | | | | | | | | | |
| | octahedral | | | | | | | | | |
| 9 | Spherical | 8.8 | 0.28 | 0.30 | 0.28 | 90 | 2.66 | 1.0 | 0.50 | 1.10 |
| | + | | | | | | | | | |
| | octahedral | | | | | | | | | |
| 10 | Spherical | 8.8 | 0.28 | 0.30 | 0.28 | 90 | 2.65 | 1.0 | 0.50 | 1.10 |
| | + | | | | | | | | | |
| | hexahedral | | | | | | | | | |
| 11 | Spherical | 8.8 | 0.28 | 0.28 | 0.28 | 90 | 2.65 | 1.0 | 0.50 | 1.10 |
| | + | | | | | | | | | |
| | hexahedral | | | | | | | | | |
| 12 | Spherical | 8.9 | 0.30 | 0.28 | 0.30 | 91 | 2.64 | 1.1 | 0.60 | 1.20 |
| | + | | | | | | | | | |
| | hexahedral | | | | | | | | | |
| 13 | Spherical | 9.0 | 0.31 | 0.31 | 0.31 | 91 | 2.64 | 1.1 | 0.60 | 1.20 |
| | + | | | | | | | | | |
| | hexahedral | | | | | | | | | |
| 14 | Spherical | 1.0 | 0.09 | 0.09 | 0.09 | 84 | 2.82 | 1.1 | 0.60 | 1.20 |
| | + | | | | | | | | | |
| | hexahedral | | | | | | | | | |
| 15 | Spherical | 100 | 0.31 | 0.31 | — | 91 | 2.10 | 1.1 | 0.60 | 1.20 |
| 16 | Hexahedral | — | 0.31 | — | 0.31 | 91 | 2.90 | 1.1 | 0.60 | 1.20 |

In the table, internal Si content values denote the proportion of Si relative to 100 atoms of iron element contained in the magnetic iron oxide particles. Surface Si content and surface Al content values denote the proportions of Si and Al relative to 100 atoms of iron element contained in the magnetic iron oxide particles.

Production Example of Binder Resin 1

Monomers for producing polyester resin: 85 parts
Adduct of (2.2 moles of) propylene oxide to bisphenol A: 100.0 parts by mole
Terephthalic acid: 65.0 parts by mole
Trimellitic anhydride: 25.0 parts by mole
Acrylic acid: 10.0 parts by mole

A mixture of monomers for producing a polyester resin was placed in a four-neck flask, a depressurization device, a water separation device, a nitrogen gas introduction device, a temperature measurement device and a stirring device were attached to the flask, and stirring was carried out at 160° C. in a nitrogen atmosphere. Next, 15 parts of vinyl-based copolymerization monomers that constitute the StAc moiety (75.0 parts of styrene and 25.0 parts of 2-ethylhexyl acrylate) and 1 part of benzoyl peroxide as a polymerization initiator were added dropwise from a dropping funnel over a period of 4 hours, and a reaction was carried out for 5 hours at 160° C. The temperature was then increased to 230° C., dibutyl tin oxide was added at an amount of 0.2 parts relative to the total amount of polyester monomer components, and a polymerization reaction was carried out until a desired softening point of 230° C. was reached. Following completion of the reaction, the reaction mixture was removed from the vessel, cooled and then pulverized so as to obtain binder resin 1. Binder resin 1 had a softening point of 140° C.

Production Example of Binder Resin 2

A monomer mixture that constitutes a polyester unit used when producing binder resin 2 is as follows.
Adduct of (2.2 moles of) propylene oxide to bisphenol A: 100.0 parts by mole
Terephthalic acid: 75.0 parts by mole
Trimellitic anhydride: 25.0 parts by mole

100 parts of the monomers listed above and 0.2 parts of titanium tetrabutoxide were supplied to a 5 liter autoclave. A reflux condenser, a moisture separator, a N2 gas inlet tube, a temperature gauge and a stirrer were attached to the autoclave, and a polycondensation reaction was carried out at 230° C. while introducing N2 gas into the autoclave. Moreover, when the reaction was carried out, the reaction time was adjusted so as to achieve a desired softening point. Following completion of the reaction, binder resin 2 was obtained by removing the obtained resin from the container and then cooling and pulverizing the resin. Binder resin 2 had a softening point of 140° C.

Production Example of Binder Resin 3
Styrene: 90.0 parts by mole
Dodecyl methacrylate: 10.0 parts by mole

5 parts of benzoyl peroxide were added as a polymerization initiator to 100 parts of the monomers listed above, and xylene was added dropwise over a period of 4 hours. Polymerization was then carried out under xylene refluxing until a softening point of 140° C. was achieved. Binder resin 3 was then obtained by increasing the temperature so as to distill off the organic solvent, cooling to room temperature, and then pulverizing. Binder resin 3 had a softening point of 140° C.

Production Example of Charge Control Resin

200 parts of methanol, 150 parts of 2-butanone and 50 parts of 2-propanol were added as solvents to a pressurizable reaction vessel equipped with a reflux tube, a stirrer, a temperature gauge, a nitrogen inlet tube, a dropwise addition device and a depressurization device, after which 78 parts of styrene, 15 parts of n-butyl acrylate and 7 parts of 2-acrylamido-2-methylpropane sulfonic acid were added as monomers, and the contents of the reaction vessel were heated to 70° C. while being stirred. A solution obtained by diluting 1 part of 2,2′-azobis(2-methylbutyronitrile) as a polymerization initiator with 20 parts of 2-butanone was added dropwise over a period of 1 hour, stirring was continued for a further 5 hours, and then a solution obtained by diluting 1 part of 2,2′-azobis(2-methylbutyronitrile) with 20 parts of 2-butanone was added dropwise over a period of 30 minutes, after which stirring was carried out for a further 5 hours and polymerization was completed. After distilling off the polymerization solvent under reduced pressure, the obtained polymer was coarsely pulverized to a size of 100 μm or less using a cutter mill equipped with a 150 mesh screen. The obtained sulfur-containing copolymer had a glass transition temperature (Tg) of 74° C., a weight average molecular weight (Mw) of 27,000, and an acid value of 23 mg KOH/g. This is referred to as sulfur-containing copolymer (S-1).

Production Example of Toner No. 1

Materials used in the production of Toner No. 1 are listed below. Moreover, Table 3 shows combinations and numbers of parts by mass of binder resins and magnetic iron oxide particles used, and also shows toner characteristics.
Binder resin 1: 100.0 parts
Fischer Tropsch wax: 3.0 parts

(C105 produced by Sasol, melting point 105° C.)
Magnetic iron oxide particles 1: 75.0 parts
Sulfur-containing copolymer (S-1): 4.0 parts

First, the materials listed above were pre-mixed using a Henschel mixer and then melt kneaded using a twin screw kneading extruder. At this point, the residence time was controlled so that the temperature of the kneaded resin was 150° C. Toner particles having a weight average particle diameter (D4) of 7.3 μm were obtained by cooling the obtained kneaded product, coarsely pulverizing using a hammer mill, pulverizing using a Turbo mill, and classifying the obtained finely pulverized powder using a multiple section sorting apparatus using the Coanda effect (an elbow jet sorting apparatus produced by Nittetsu Mining Co., Ltd.). Toner No. 1 was obtained by externally adding 2.0 parts of a hydrophobic silica fine powder (which had a nitrogen adsorption specific surface area, as measured using the BET method, of 140 m²/g and had been treated with hexamethyldisilazane as a hydrophobic treatment) to 100 parts of the toner particles, mixing and sieving with a mesh having an opening size of 150 μm. Toner No. 1 was subjected to the evaluations described below. The evaluation results are shown in Table 4.

The toner was evaluated using an evaluation device obtained by modifying a commercially available digital copier (an image RUNNER ADVANCE 8105 PRO available from Canon, Inc.) to a processing speed of 600 mm/s.

Evaluation of Dot Reproducibility

Each magnetic toner was left to stand for a long period of time in an environment considered to be harsher for dot reproducibility (1 month at a temperature of 45° C. and a relative humidity (RH) of 95%). Next, after printing 100,000 test charts having a print coverage rate of 5% in a high temperature high humidity environment (30° C., 80% RH), a half tone (30H) image was formed, and the roughness of this image was evaluated using the criteria below. The paper used was CS-068 A4 paper (basis weight 68.0 g/m², sold by Canon Marketing Japan K.K.). Moreover, a 30H image is a half tone image in which 256 gradations are values expressed as hexadecimal numbers, with OOH denoting solid white (no image) and FFH denoting solid black (a whole image). The area of 1000 dots in the image was measured using a VHX-500 digital microscope (wide-range zoom lens VH-Z100, produced by Keyence Corporation). The number average dot area (S) and standard deviation (σ) of dot area were calculated, and the dot reproducibility index was calculated using the following formula.

Dot reproducibility index (I)=σ/S×100
A: I is less than 2.0
B: I is at least 2.0 but less than 4.0
C: I is at least 4.0 but less than 6.0
D: I is at least 6.0 but less than 8.0
E: I is at least 8.0

Evaluation of Scattering

Evaluation of scattering means evaluation of scattering on a fine line, which is related to image quality of a graphic image, and was carried out by visually evaluating line reproducibility and scattering of a toner at the periphery of a line when printing out a single dot line image, for which scattering readily occurs. This evaluation was carried out using the criteria below after printing 100,000 test charts having a print coverage rate of 5% in a low temperature low humidity environment (5° C., 5% RH), in which scattering readily occurs. The paper used was CS-068 A4 paper (basis weight 68.0 g/m², sold by Canon Marketing Japan K.K.).

Evaluation Criteria
A: No scattering and good line reproducibility
B: Almost no scattering and good line reproducibility
C: Slight scattering observed
D: Scattering observed, but no effect on line reproducibility
E: Significant scattering observed, and poor line reproducibility

Evaluation of Tailing

Evaluation of tailing was carried out using the criteria below after printing 100,000 test charts having a print coverage rate of 5% in a low temperature low humidity environment (5° C., 5% RH), in which tailing readily occurs. Three horizontal line images were printed at intervals of 1 cm on a paper under conditions adapted to a line width of 168 μm. This image was magnified 150 times using an optical microscope, line widths were measured at intervals of 3 μm in the magnified image, and the standard deviation of line with was determined. The average value for the three lines was determined from the standard deviation of the lines, and the level of tailing was evaluated using the criteria below. The paper used was CS-068 A4 paper (basis weight 68.0 g/m², sold by Canon Marketing Japan K.K.).

Evaluation Criteria
A: Standard deviation is not more than 3.0
B: Standard deviation is more than 3.0 and not more than 5.0
C: Standard deviation is more than 5.0 and not more than 7.0
D: Standard deviation is more than 7.0 and not more than 10.0
E: Standard deviation is more than 10.0

Evaluation of Half Tone Unevenness

Half tone unevenness was evaluated by outputting a two-dot three-space half tone image at a resolution of 600 dpi in a low temperature low humidity (5° C., 5% RH) environment, and visually evaluating the half tone image quality (gradation unevenness in development) of the obtained image. The evaluation paper was CS-520 (basis weight: 52.0 g/m² paper, A4 size, sold by Canon Marketing Japan Inc.), and the evaluation paper was used after being left in a high temperature high humidity environment for 48 hours or more so that the paper was thoroughly moistened.

Evaluation Criteria
A: No gradation unevenness experienced
B: Very slight gradation unevenness observed, but of little concern
C: Slight gradation unevenness observed
D: Gradation unevenness could be confirmed
E: Gradation unevenness very noticeable

Evaluation of Image Density

Image density was evaluated after continuously feeding 10 test charts having a print coverage rate of 5% in a variety of environments [a normal temperature normal humidity (23° C., 55% RH) environment, a high temperature high humidity (30° C., 80% RH) environment and a low temperature low humidity (5° C., 5% RH) environment]. 10,000 sheets were then continuously fed in a low temperature low humidity environment, after which evaluations were carried out in the same way, and it was evaluated whether or not excessive toner electrification could be suppressed. Toner image density decreased in a case where excessive toner electrification occurred by continuously feeding 10,000 sheets. The evaluation paper was CS-068 (basis weight: 68.0 g/m², A4, sold by Canon Marketing Japan K.K.). In this evaluation method, an original image was outputted in such a way that solid black patches measuring 20 mm on each side were disposed at five locations within a development region, and the average density at these five points was taken to be the image density. Moreover, image density was measured using an X-Rite color reflection densitometer (X-Rite 500 Series available from X-Rite Inc.).

Evaluation Criteria
A: Image density of at least 1.40
B: Image density of at least 1.20 but less than 1.40
D: Image density of less than 1.20

Evaluation of Fogging

Fogging was evaluated after continuously feeding 10 test charts having a print coverage rate of 5% in a variety of environments [a normal temperature normal humidity (23° C., 55% RH) environment, a high temperature high humidity (30° C., 80% RH) environment and a low temperature low humidity (5° C., 5% RH) environment]. 10,000 sheets were then continuously fed in a low temperature low humidity environment, after which evaluations were carried out in the same way, and it was evaluated whether or not excessive toner electrification could be suppressed. The occurrence of fogging was significant in a case where excessive toner electrification occurred by continuously feeding 10,000 sheets. In this evaluation method, a solid white image was evaluated using the criteria below. Moreover, measurements were carried out using a reflectance meter (a TC-6DS model reflectometer available from Tokyo Denshoku Co., Ltd.), and fogging was evaluated using the value of Dr-Ds as the amount of fogging, where Ds denotes the worst value of reflection density on white background parts following image formation, and Dr denotes the average reflection density on the transfer material prior to image formation. Therefore, a lower value means that less fogging occurs. The evaluation paper was CS-068 (basis weight: 68.0 g/m², A4, sold by Canon Marketing Japan K.K.).

Evaluation Criteria
A: Fogging amount of less than 1.5
B: Fogging amount of at least 1.5 but less than 2.0
C: Fogging amount of at least 2.0

### Working Examples 2 to 18

Toner Nos. 2 to 18 were produced in the same way as in Working Example 1, except that formulations were changed in the manner shown in Table 3. In addition, Toner Nos. 2 to 18 were evaluated using the same methods as those used in Working Example 1. The evaluation results are shown in Table 4. Moreover, it was confirmed that magnetic iron oxide particles were in a dispersed state in a binder resin in the obtained toners.

TABLE 3

| | | | | | | | | Proportion |
|---|---|---|---|---|---|---|---|---|
| | | | | | | | | (% by number) |
| | Binder resin | | Magnetic iron oxide | | | | Magnetic | of spherical |
| | Binder | | Magnetic | | Magnetic | | iron oxide | magnetic iron oxide |
| | resin | | iron oxide | | iron oxide | | content | particles in magnetic |
| Toner No. | No. | parts | No. | parts | No. | parts | (mass %) | iron oxide particles |
| Toner1 | Binder | 100.0 | Magnetic | 75.0 | — | — | 40 | 5.0 |
| | resin 1 | | iron oxide 1 | | | | | |
| Toner 2 | Binder | 100.0 | Magnetic | 60.0 | — | — | 35 | 2.0 |
| | resin 1 | | iron oxide 2 | | | | | |
| Toner 3 | Binder | 100.0 | Magnetic | 80.0 | — | — | 42 | 7.0 |
| | resin 1 | | iron oxide 3 | | | | | |
| Toner 4 | Binder | 100.0 | Magnetic | 80.0 | — | — | 42 | 8.0 |
| | resin 1 | | iron oxide 4 | | | | | |
| Toner 5 | Binder | 100.0 | Magnetic | 80.0 | — | — | 42 | 1.5 |
| | resin 1 | | iron oxide 5 | | | | | |
| Toner 6 | Binder | 100.0 | Magnetic | 80.0 | — | — | 42 | 1.5 |
| | resin 1 | | iron oxide 6 | | | | | |
| Toner 7 | Binder | 100.0 | Magnetic | 80.0 | — | — | 42 | 8.0 |
| | resin 1 | | iron oxide 7 | | | | | |
| Toner 8 | Binder | 100.0 | Magnetic | 80.0 | — | — | 42 | 8.0 |
| | resin 2 | | iron oxide 7 | | | | | |
| Toner 9 | Binder | 100.0 | Magnetic | 80.0 | — | — | 42 | 8.1 |
| | resin 2 | | iron oxide 8 | | | | | |
| Toner 10 | Binder | 100.0 | Magnetic | 80.0 | — | — | 42 | 8.8 |
| | resin 2 | | iron oxide 9 | | | | | |
| Toner 11 | Binder | 100.0 | Magnetic | 80.0 | — | — | 42 | 8.8 |
| | resin 3 | | iron oxide 9 | | | | | |
| Toner 12 | Binder | 100.0 | Magnetic | 80.0 | — | — | 42 | 8.8 |
| | resin 3 | | iron oxide 10 | | | | | |
| Toner 13 | Binder | 100.0 | Magnetic | 80.0 | — | — | 42 | 8.8 |
| | resin 3 | | iron oxide 11 | | | | | |
| Toner 14 | Binder | 100.0 | Magnetic | 80.0 | — | — | 42 | 8.9 |
| | resin 3 | | iron oxide 12 | | | | | |
| Toner 15 | Binder | 100.0 | Magnetic | 80.0 | — | — | 42 | 9.0 |
| | resin 3 | | iron oxide 13 | | | | | |
| Toner 16 | Binder | 100.0 | Magnetic | 90.0 | — | — | 45 | 1.0 |
| | resin 3 | | iron oxide 14 | | | | | |
| Toner 17 | Binder | 100.0 | Magnetic | 50.0 | — | — | 31 | 9.0 |
| | resin 3 | | iron oxide 13 | | | | | |
| Toner 18 | Binder | 100.0 | Magnetic | 4.5 | Magnetic | 45.5 | 31 | 9.0 |
| | resin 3 | | iron oxide 15 | | iron oxide 16 | | | |

TABLE 4

| Example | Toner | Dot | | | Half tone | Image density | | | Fogging | | |
|---|---|---|---|---|---|---|---|---|---|---|---|
| No. | No. | reproducibility | Scattering | Tailing | unevenness | (N/N) | (L/L) | (H/H) | (N/N) | (L/L) | (H/H) |
| Example 1 | Toner 1 | A(1.7) | A | A(1.9) | A | A(1.48) | A(1.48) | A(1.48) | A(0.10) | A(0.10) | A(0.10) |
| Example 2 | Toner 2 | A(1.7) | A | A(2.1) | A | A(1.48) | A(1.48) | A(1.48) | A(0.10) | A(0.10) | A(0.10) |
| Example 3 | Toner 3 | A(1.7) | A | A(2.1) | A | A(1.48) | A(1.48) | A(1.48) | A(0.10) | A(0.10) | A(0.10) |
| Example 4 | Toner 4 | A(1.8) | A | A(2.3) | B | A(1.48) | A(1.48) | A(1.48) | A(0.20) | A(0.20) | A(0.10) |
| Example 5 | Toner 5 | A(1.8) | A | A(2.5) | B | A(1.48) | A(1.48) | A(1.48) | A(0.20) | A(0.20) | A(0.10) |
| Example 6 | Toner 6 | A(1.8) | A | A(2.6) | C | A(1.48) | A(1.48) | A(1.47) | A(0.30) | A(0.30) | A(0.20) |
| Example 7 | Toner 7 | A(1.9) | A | A(2.6) | C | A(1.48) | A(1.48) | A(1.47) | A(0.30) | A(0.30) | A(0.20) |
| Example 8 | Toner 8 | A(1.9) | B | A(2.7) | C | A(1.48) | A(1.48) | A(1.47) | A(0.30) | A(0.30) | A(0.20) |
| Example 9 | Toner 9 | B(2.9) | B | A(2.8) | C | A(1.47) | A(1.47) | A(1.47) | A(0.30) | A(0.30) | A(0.20) |
| Example 10 | Toner 10 | B(3.1) | B | B(3.3) | C | A(1.47) | A(1.47) | A(1.47) | A(0.30) | A(0.30) | A(0.20) |
| Example 11 | Toner 11 | B(3.5) | C | B(3.7) | C | A(1.47) | A(1.47) | A(1.46) | A(0.30) | A(0.30) | A(0.30) |
| Example 12 | Toner 12 | B(3.8) | C | B(3.9) | D | A(1.47) | A(1.47) | A(1.46) | A(0.30) | A(0.30) | A(0.30) |
| Example 13 | Toner 13 | C(4.8) | C | B(4.2) | D | A(1.46) | A(1.46) | A(1.46) | A(0.40) | A(0.40) | A(0.30) |
| Example 14 | Toner 14 | C(4.9) | C | C(5.5) | D | A(1.46) | A(1.46) | A(1.46) | A(0.40) | A(0.40) | A(0.30) |
| Example 15 | Toner 15 | C(5.0) | D | C(6.5) | D | A(1.46) | A(1.46) | A(1.46) | A(0.40) | A(0.40) | A(0.30) |
| Example 16 | Toner 16 | C(5.3) | D | D(7.5) | D | A(1.46) | A(1.46) | A(1.46) | A(0.40) | A(0.40) | A(0.30) |
| Example 17 | Toner 17 | C(5.4) | D | D(7.5) | D | A(1.46) | A(1.46) | A(1.45) | A(0.40) | A(0.40) | A(0.30) |
| Example 18 | Toner 18 | D(7.0) | D | D(9.0) | D | A(1.46) | A(1.46) | A(1.45) | A(0.40) | A(0.40) | A(0.30) |

### Comparative Examples 1 to 6

Toner Nos. 19 to 24 were produced in the same way as in Working Example 1, except that formulations were changed in the manner shown in Table 5. In addition, Toner Nos. 19 to 24 were evaluated using the same methods as those used in Working Example 1. The evaluation results are shown in Table 6.

TABLE 5

| | | | | | | | | Proportion |
|---|---|---|---|---|---|---|---|---|
| | | | | | | | | (% by number) |
| | | | | | | | | of spherical |
| | | | | | | | Magnetic | magnetic iron |
| | Binder resin | | Magnetic iron oxide | | | | iron oxide | oxide particles |
| | Binder resin | | Magnetic | | Magnetic | | content | in magnetic iron |
| Toner No. | No. | parts | iron oxide No. | parts | iron oxide No. | parts | (mass %) | oxide particles |
| Toner 19 | Binder resin 3 | 100.0 | Magnetic | 4.6 | Magnetic | 45.4 | 31 | 9.2 |
| | | | iron oxide 15 | | iron oxide 16 | | | |
| Toner 20 | Binder resin 3 | 100.0 | Magnetic | 0.4 | Magnetic | 49.6 | 31 | 0.8 |
| | | | iron oxide 15 | | iron oxide 16 | | | |
| Toner 21 | Binder resin 3 | 100.0 | Magnetic | 9.0 | Magnetic | 91.0 | 47 | 9.0 |
| | | | iron oxide 15 | | iron oxide 16 | | | |
| Toner 22 | Binder resin 3 | 100.0 | Magnetic | 3.6 | Magnetic | 36.4 | 27 | 9.0 |
| | | | iron oxide 15 | | iron oxide 16 | | | |
| Toner 23 | Binder resin 3 | 100.0 | Magnetic | 50.0 | — | — | 31 | 100.0 |
| | | | iron oxide 15 | | | | | |
| Toner 24 | Binder resin 3 | 100.0 | Magnetic | 50.0 | — | — | 31 | 0.0 |
| | | | iron oxide 16 | | | | | |

TABLE 6

| Example | Toner | Dot | | | Half tone | Image density | | | Fogging | | |
|---|---|---|---|---|---|---|---|---|---|---|---|
| No. | No. | reproducibility | Scattering | Tailing | unevenness | (N/N) | (L/L) | (H/H) | (N/N) | (L/L) | (H/H) |
| Comparative | Toner 19 | E (8.1) | E | E (10.5) | E | A(1.45) | A(1.47) | A(1.46) | A(0.8) | A(0.9) | A(0.9) |
| Example 1 | | | | | | | | | | | |
| Comparative | Toner 20 | E (8.1) | E | E (10.5) | E | A(1.45) | A(1.47) | A(1.46) | A(0.8) | A(0.8) | A(0.7) |
| Example 2 | | | | | | | | | | | |
| Comparative | Toner 21 | E (8.3) | E | E (11.0) | E | A(1.45) | A(1.47) | A(1.46) | A(0.8) | A(0.8) | A(0.7) |
| Example 3 | | | | | | | | | | | |
| Comparative | Toner 22 | E (8.4) | E | E (11.1) | E | A(1.42) | A(1.45) | A(1.41) | A(0.9) | A(0.9) | A(0.8) |
| Example 4 | | | | | | | | | | | |
| Comparative | Toner 23 | E (8.6) | E | E (12.0) | E | A(1.45) | A(1.47) | A(1.46) | A(0.9) | A(0.9) | A(0.8) |
| Example 5 | | | | | | | | | | | |
| Comparative | Toner 24 | E (8.6) | E | E (12.8) | E | A(1.45) | A(1.47) | A(1.46) | A(0.9) | A(0.9) | A(0.8) |
| Example 6 | | | | | | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-013428, filed Jan. 29, 2021, and Japanese Patent Application No. 2022-001097, filed Jan. 6, 2022, which are hereby incorporated by reference herein in their entirety.

What is claimed is:

1. A magnetic toner comprising a toner particle comprising a binder resin and magnetic iron oxide particles, wherein
a content of the magnetic iron oxide particles in the magnetic toner is 30 to 45 mass %,
the magnetic iron oxide particles contain
(i) spherical magnetic iron oxide particles and
(ii) at least one selected from the group consisting of hexahedral magnetic iron oxide particles and octahedral magnetic iron oxide particles, and
a content of the spherical magnetic iron oxide particles in the magnetic iron oxide particles is 1.0 to 9.0% by number.

2. The magnetic toner according to claim 1, wherein the content of the spherical magnetic iron oxide particles in the magnetic iron oxide particles is 1.5 to 8.0% by number.

3. The magnetic toner according to claim 1, wherein the content of the spherical magnetic iron oxide particles in the magnetic iron oxide particles is 2.0 to 7.0% by number.

4. The magnetic toner according to claim 1, wherein a number average particle diameter of the magnetic iron oxide particles is 0.1 to 0.30 μm.

5. The magnetic toner according to claim 1, wherein an intensity of magnetization of the magnetic iron oxide particles in a magnetic field of 796 kA/m is 85 to 90 Amt/kg.

6. The magnetic toner according to claim 1, wherein a number average particle diameter of the spherical magnetic iron oxide particles is greater than a number average particle diameter of the at least one selected from the group consisting of the hexahedral magnetic iron oxide particles and the octahedral magnetic iron oxide particles.

7. The magnetic toner according to claim 1, wherein
the magnetic iron oxide particles contain
(i) spherical magnetic iron oxide particles and
(ii) octahedral magnetic iron oxide particles.

8. The magnetic toner according to claim 1, wherein the binder resin comprises a hybrid resin in which a polyester resin is bound to a vinyl-based resin.

9. The magnetic toner according to claim 1, wherein a maximum specific magnetic permeability of the magnetic iron oxide particles in a magnetic field of 0 to 796 kA/m is 2.70 to 2.80.

10. The magnetic toner according to claim 1, wherein the magnetic iron oxide particles are present in a dispersed state in the binder resin.

11. The magnetic toner according to claim 1, wherein the magnetic iron oxide particles have: a core particle containing a silicon-containing compound; and, on a surface of the core particle, a coat layer containing a silicon-containing compound and an aluminum-containing compound.
